(19) United States
(12) Patent Application Publication
(10) Pub. No.: US 2026/0197370 A1
(43) Pub. Date: Jul. 9, 2026

(54) COMMUNICATION CONTROL DEVICE AND CONTROL COMMUNICATION SYSTEM

(71) Applicant: Hitachi High-Tech Corporation, Minato-ku, Tokyo (JP)

(72) Inventors: Tatsuya MARUYAMA, Tokyo (JP); Koichi Yamamoto, Tokyo (JP); Junichi Kitamura, Tokyo (JP); Koichi Terada, Tokyo (JP)

(21) Appl. No.: 18/839,950

(22) PCT Filed: Jun. 16, 2023
(86) PCT No.: PCT/JP2023/022405

§ 371 Date: Aug. 20, 2024

(51) Int. Cl. H04L 67/125; H04L 7/00; H04L 47/625; H04L 47/70; H04L 49/9057

(52) U.S. Cl. CPC H04L 67/125; H04L 7/0091; H04L 47/626; H04L 47/826; H04L 49/9057

(57) ABSTRACT

Provided are a communication control device and a control communication system that can improve communication performance and calculation performance and can also cope with an increase in a data capacity. There are provided an calculation unit that processes control data, a communication unit that transmits a packet including the control data, and a data storage unit having an exclusion control function. The calculation unit associates a position occupied by each of two or more pieces of partial data constituting the control data in the control data with an attribute related to a packet communicated by the communication unit, and transmits and receives the partial data to and from the communication unit via the data storage unit.

### TECHNICAL FIELD

The present invention relates to techniques for a control communication system, a communication control device, a control data processing method, and a control data processing program.

### BACKGROUND ART

Patent Literature 1 discloses a communication node that includes a communication controller and a data processing device in order to increase processing performance regardless of processing performance of a CPU. The communication controller transmits information to be transmitted to a transmission path, and stores information received from the transmission path in a storage device. The data processing device calculates a transmission time of an own communication node based on the received information and information preset in the own communication node, counts the calculated transmission time from a time point when completion of writing by the communication controller is detected, and notifies the communication controller of a transmission command.

Non-Patent Literature 1 defines elements and rules for describing both a communication network profile and a device profile in an Ethernet-based control system.

### CITATION LIST

### Patent Literature

Patent Literature 1: JP2000-76163A

### Non Patent Literature

Non-Patent Literature 1: ISO 14745-4 Industrial Automation Systems and Integration Open Systems Application, Integration Frameworks Part 4 Reference Description for Ethernet-based Control Systems

### SUMMARY OF INVENTION

### Technical Problem

A control system supporting social infrastructure includes a sensor, a controller, and an actuator. The sensor acquires a state of a physical object and inputs the state to the controller, calculates a control command value for the controller to instruct the actuator, and the actuator acts on the physical object based on the control command value. The control system executes, for example, desired control by cyclically repeating such a series of processing.

Examples of such a control system include factory automation (FA) in factories, process automation (PA) in chemical plants, a semiconductor manufacturing device, and a semiconductor inspection device. Further examples include a medical device, a distributed control system, a power system control system, a power generation plant, a water and sewage treatment system, and a steel control system.

In a large-scale control system or a complicated control system, a plurality of sensors, controllers, and actuators are connected via a network. In such a network, a technique of a control network is developed in order to satisfy a time constraint (for example, a worst delay), cost, reliability, and a requirement specific to the field, which are requirements of a control system.

In particular, driven by an increase in a scale and an increase in a level of a control system, or by recent progress of Industrial IoT, a control network constituting a control system is required to speed up communication, shorten a control communication cycle, increase a communication capacity, and the like. Further, in addition to improving communication performance, advanced data processing such as artificial intelligence (AI) processing and statistical processing in the control system itself is required to implement the Industrial IoT.

As a method to meet these needs, a control system is known in which Ethernet is introduced into a control network, as typified by Industrial Ethernet (registered trademark), in order to increase a communication capacity. Further, in such a control system, in consideration of speed-up and high performance of an embedded processor, there is a case in which a high-performance embedded processor is mounted not only on a control device side but also on an input and output device side.

However, when focusing on a configuration of such a control system, even if a capacity of communication between the control device and the input and output device is increased, there is a problem in data transmission and reception between a communication interface and a calculation function (processor or the like) on the input and output device, as described below.

### <Problem on Limitation of Built-In RAM Capacity>

In general, data is transmitted and received between the control device and the input and output device via a data buffer on the input and output device. That is, a command value and the like from the control device is stored in the data buffer via communication, and extracted by the calculation function (processor and the like) of the input and output device. Similarly, sensor data from the input and output device is stored in the data buffer and transmitted to the control device via the communication. At this time, it is necessary to maintain consistency of the data on the data buffer when storing data to and retrieving data from the data buffer.

On the other hand, depending on the device, a simultaneous access to the same address may make stored data or read data undefined. Consistency may need to be maintained over a significant area rather than just one element of the data buffer. In response to such a request, for example, it is assumed that accesses to a predetermined area of the data buffer by the communication and the calculation function occur almost simultaneously, and since access speeds are different, one overtakes the other in terms of accessed addresses. In this case, the overtaken side means that the consistency of the data is lost because the data is updated in the middle.

Such problems are more apparent as the performance of the control system increases, that is, as a communication cycle of the control device and a control cycle of the input and output device are shorter and faster. In order to solve such problems, a special mechanism for exclusion control is required in the data buffer. In addition, high-speed processing is required to keep up with the high performance of the control system.

These requests make it difficult to apply an external random access memory (RAM) and a nonvolatile storage media, and an application of a built-in RAM having a special mechanism is being directed. However, a problem with such a built-in RAM is that it is generally difficult to increase a data capacity, making it difficult to respond to an increase in input and output data, which is another request of the control system.

### <Request for Separation of Calculation Function (Processor)>

Another problem is that a request on the control system is becoming more diverse, including not only high control performance but also an application of AI processing. In order to meet such a request, it is desirable to have a configuration in which a communication function and the calculation function are separated in the input and output device.

It is difficult for a transfer memory system shown in Patent Literature 1 and Non-Patent Literature 1 to solve the above problems. The invention aims, for example, to solve the above problems.

The above and other objects and novel features of the invention will become apparent from the description of this specification and the accompanying drawings.

### Solution to Problem

In one embodiment, in order to solve the above problem, there is provided a communication control device including a calculation unit that processes control data, a communication unit that transmits a packet including the control data, and a data storage unit having an exclusion control function. The calculation unit associates a position occupied by each of two or more pieces of partial data constituting the control data in the control data with an attribute related to a packet communicated by the communication unit, and transmits and receives the partial data to and from the communication unit via the data storage unit.

### Advantageous Effects of Invention

According to one embodiment, it is possible to improve communication performance and calculation performance, and it is also possible to cope with an increase in a data capacity.

### BRIEF DESCRIPTION OF DRAWINGS

FIG. 1 is a schematic view showing a configuration example of a control communication system according to a first embodiment.

FIG. 2 is a block diagram showing a hardware configuration example of a control device shown in FIG. 1.

FIG. 3 is a block diagram showing a functional configuration example of the control device shown in FIG. 1.

FIG. 4 is a block diagram showing a hardware configuration example of a control target device shown in FIG. 1.

FIG. 5 is a block diagram showing a functional configuration example of a control target device communication control IC shown in FIG. 4.

FIG. 6 is a block diagram showing a functional configuration example of a communication processing unit shown in FIG. 5.

FIG. 7 is a flow diagram showing an example of a transmission procedure executed by the control device shown in FIG. 3.

FIG. 8 is a flow diagram showing an example of a reception procedure executed by the control target device in FIGS. 5 and 6.

FIG. 9 is a flow diagram showing an example of an integrated management procedure for received data executed by the control target device in FIG. 6.

FIG. 10 is a flow diagram showing an example of a transmission procedure executed by the control target device in FIGS. 5 and 6.

FIG. 11 is a flow diagram showing an example of an integrated management procedure for transmission data executed by the control target device.

FIG. 12 is a flow diagram showing an example of a reception procedure executed by the control device in FIG. 3.

FIG. 13 is a flow diagram showing an example of a procedure in which a communication schedule configuration unit determines a communication schedule in FIG. 3.

FIG. 14A is a schematic view showing a specific example of a communication schedule determined by the flow shown in FIG. 13.

FIG. 14B is a schematic view showing a specific example of the communication schedule determined by the flow shown in FIG. 13.

FIG. 14C is a schematic view showing a specific example different from FIG. 14B.

FIG. 14D is a schematic view showing a specific example further different from FIG. 14B.

FIG. 15A is a diagram illustrating a specific operation example of the control target device in FIG. 9.

FIG. 15B is a diagram showing an assignment of a logical address for each control target device in FIG. 15A and an example of setting FMMU for the control target device.

FIG. 15C is a diagram showing an assignment of each area in a data storage unit and a setting example of SyncManager in the control target device shown in FIG. 15A.

FIG. 15D is a diagram showing an example of a data assignment to the integrated data storage unit performed by a data integration management unit in the control target device shown in FIG. 15A.

FIG. 16 is a schematic view showing an example of a problem when an error occurs in time instant management between the control device and the control target device.

FIG. 17A is a time chart showing an operation example when the data integration management unit in FIG. 6 writes input data in the data storage unit on the premise that time synchronization is performed.

FIG. 17B is a time chart showing an operation example when the data integration management unit in FIG. 6 writes the input data in the data storage unit on the premise that the time synchronization is not performed.

FIG. 18 is a time chart showing an operation example that is a modification of FIG. 17B.

FIG. 19 is a time chart showing an operation example when the data integration management unit in FIG. 6 writes the input data in the data storage unit on the premise that retransmission and cable redundant communication are performed.

FIG. 20A is a schematic view showing an example of a situation in which a cable failure occurs between a control target device and a control target device.

FIG. 20B is a schematic view showing an example of a situation different from FIG. 20A.

FIG. 21 is a schematic view showing a configuration example of the integrated data storage unit in FIG. 6.

FIG. 22A is a block diagram showing a configuration example obtained by modifying the hardware configuration of the control target device shown in FIG. 4.

FIG. 22B is a block diagram showing a configuration example different from that shown in FIG. 22A.

FIG. 23 is a schematic view showing a configuration example in which the control communication system shown in FIG. 1 is modified.

FIG. 24 is a block diagram showing a configuration example obtained by modifying the functional configuration of the communication processing unit shown in FIG. 6.

### DESCRIPTION OF EMBODIMENTS

Hereinafter, embodiments of the invention will be described in detail with reference to the drawings. In all drawings illustrating the embodiments, the same members are denoted by the same reference numerals in principle, and repeated description thereof will be omitted.

### <Overview of Control Communication System>

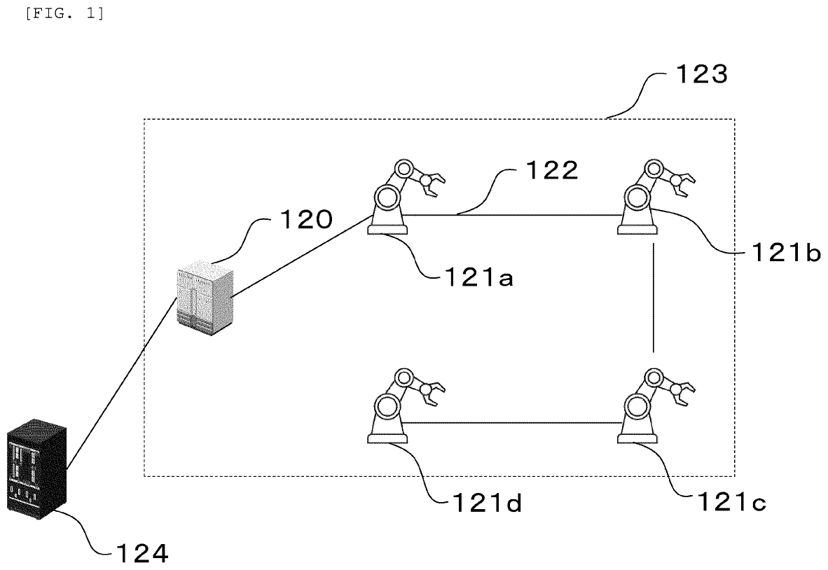

FIG. 1 is a schematic view showing a configuration example of a control communication system according to a first embodiment. In FIG. 1, a control device (first communication control device) 120 communicates with control target devices (second communication control devices) 121a to 121d via a control network 122, and controls the control target devices. In the specification, the control target devices 121a to 121d are collectively referred to as the control target device 121. Specifically, the control device 120 transmits a communication packet to and receives a communication packet from the control target device 121, thereby transmitting a control command value to the control target device 121 such as a sensor and an actuator, acquiring a measured value or sensor information from the control target device 121, and executing various settings or the like for the control target device 121.

The control device 120 is a device that exchanges sampling data, a control command, and a state signal in a control system such as a controller in a semiconductor manufacturing device or a semiconductor inspection device, a central control device of a distributed control system (DCS), and a protection controller of a power system. The control device 120 may store a plurality of pieces of data in the same control system in a packet.

The control device 120 may support a software virtualization technology or a software container technology, and may be implemented to manage an application or an operating system (OS) as a container by virtualization.

Specific examples of the control device 120 include a dedicated controller, an industrial personal computer, a control computer, a DCS controller, a multi-access edge computing (MEC) device, a computer cloud, a server, and a supervisory control and data acquisition (SCADA) server. Further examples include a programmable logic controller (PLC), an intelligent electronic device (IED), a protection controller, and a cloud server.

The control target device 121 is a device such as a sensor and an actuator, and executes device control and device settings according to a control command received from the control device 120 via the control network 122. The control target device 121 acquires a state and information of a device and transmits the state and the information to the control device 120 via the control network 122. The control target device 121 may only have a function of inputting information such as a sensor, may only have a function of outputting information such as an actuator, or may have both functions of inputting and outputting.

Specific examples of the control target device 121 include a mobile robot, a humanoid robot, an industrial robot such as a robot arm, automated guided vehicles (AGVs), and autonomous mobile robots (AMRs). In addition, examples include an autonomous mobile object or a remote-controlled mobile object, a chip mounter, a machine tool table, a device, a machine tool, a semiconductor processing manufacturing device, and a semiconductor inspection device.

Further, specific examples of the control target device 121 include a medical device such as a clinical testing device, a power device such as a motor, an inverter, a servo amplifier, and a servo motor in a manufacturing device, a circuit breaker, and a disconnector, and various sensors (an encoder, a temperature sensor, a pressure sensor, and the like). Alternatively, examples include a dedicated controller, an industrial personal computer, a control computer, a DCS controller, a SCADA device, a PLC, a smartphone or a communication device including a wireless communication interface, an intelligent electronic device (IED), a merging unit (MU), and a protection controller.

The control network 122 is a network that connects the control device 120 and the control target device 121. Specific examples of the control network 122 include a network based on IEEE 802.3 (Ethernet) including a control network such as EtherCAT (registered trademark), IEC 61784, and time sensitive networking (TSN). Regarding the IEEE 802.3, examples include standards that support communication speeds such as 100 Mbps, 1 Gbps, multi-gigabit Ethernet, and 10 Gbps, and the use of jumbo frames.

Further, specific examples of the control network 122 include a core network in a wireless network such as 5G, 6G, or 4G. Further examples include a wired network such as a controller area network (CAN, registered trademark), RS-232C, and a universal serial bus (USB, registered trademark), and various wireless networks such as Bluetooth (registered trademark).

Examples of an upper protocol in a protocol stack include an OPC unified architecture (UA), a data distribution service (DDS), and a communication protocol based on a service based interface (SBI). Alternatively, examples include REST API, HTTP/2, open API, JavaScript object notation (JSON) data, and IEC 61850. The above protocols may be hierarchized. For example, a content of a data area on TSN applies an OPC UA standard.

In the embodiment, EtherCAT will be described as an example. An EtherCAT network mainly has the following features (a) to (c).

(a) The control device 120 and the control target device 121 are connected, and a control packet sent from the control device 120 sequentially passes through one or more control target devices 121 and returns to the control device 120. For example, a topology includes a line topology, a ring topology, and a star topology. A relay device adapted to the EtherCAT is used as necessary.

(b) One control packet may include control data for each of a plurality of control target devices 121.

Accordingly, the control device 120 only needs to transmit and receive a smaller number of packets than a case in which the control device 120 individually transmits packets to and receiving packets from a plurality of control target devices 121.

(c) When a control packet including a control command to each of a plurality of control target devices 121 is sent from the control device 120, the control packet is sequentially transferred to the control target devices 121 according to a connection order with a network, and then returns to the control device 120 which is a transmission source.

A control system 123 includes the control device 120, the control target device 121, and the control network 122. Specific examples of the control system 123 include control systems of DCS or the like for a semiconductor manufacturing device, a semiconductor inspection device, a medical device such as a clinical testing device, factory automation (FA), and process automation (PA). In addition, examples include a remote control system via a wireless network, a monitoring control and protection control system in the power field, a control system in an industrial device, an in-vehicle system, a construction machine or a railway vehicle, a railway ground signal system, and a control system in an aircraft.

Alternatively, the control system 123 may be a component of these devices or systems. For example, the control system 123 may be a component of a chamber of an etching device or a sputtering device which is a semiconductor manufacturing device, a manufacturing line of an FA system, a device constituting a DCS, an in-vehicle system, and an aircraft control system.

A control system management device 124 is a device that is connected to the control device 120 and controls and manages the control device 120. For example, the control system management device 124 sets and acquires a control parameter, a control policy, and the like for the control device 120 to execute control. In addition, the control system management device 124 may perform functional division on the control device 120 from the viewpoint of time resolution. That is, the control system management device 124 can control a control parameter, a target value, and the like of the control device 120 in a relatively long control cycle for a control cycle executed by the control device 120. In another aspect, while the control device 120 performs automatic control, the control system management device 124 allows manual control by a system operator.

Alternatively, the control system management device 124 may set a configuration of the control system 123. Specifically, the setting includes setting parameters and operation modes in the control device 120 and the control target device 121. Alternatively, an address assignment when mapping the control target device 121 to a logical address or setting of the control target device 121 related to a setting of the logical address may be performed.

When making these settings, the control system management device 124 may determine a datagram to be used for the settings, transfer the determined information to the control device 120, and cause the control device 120 to transmit the information. These settings may be performed by generating, editing, and managing EtherCAT slave information (ESI) and EtherCAT network information (ENI) in EtherCAT.

In this manner, when the control system management device 124 is used to set the control system 123, not only a setting in an online state in which the control system 123 is operated, but also a setting in an offline state before the control system 123 is operated may be used. When making these settings, the connection between the control system management device 124 and the control device 120, or the connection between the control system management device 124 and the control target device 121 may be performed only during the setting. The control system management device 124 may be directly connected to the control target device 121 without passing through the control device 120. The connection here includes not only a physical connection using the control network 122 or a network cable but also a logical connection such as a communication protocol and software for setting.

Specific examples of the control system management device 124 may be an implementation similar to that of the control device 120. The control system management device 124 may be connected to the control device 120 via the control network 122 or may be connected to the control device 120 via a network independent of the control network 122.

Specific examples of the control communication system shown in FIG. 1 include the control system 123 having the various implementation forms described above, as well as an IoT system or the like in which an analysis is performed by artificial intelligence on a cloud or a computer based on information collected via the control network 122 and performance of the control system 123 is improved. The implementations may include local 5G, private 5G, and public 5G.

### <Hardware Configuration of Control Device 120>

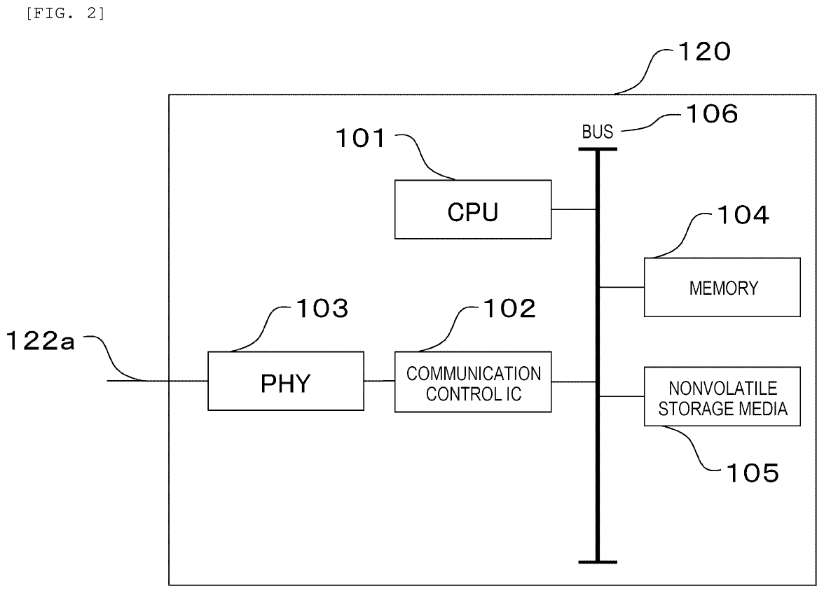

FIG. 2 block diagram showing a hardware configuration example of the control device 120 shown in FIG. 1. In FIG. 2, a CPU 101 transfers a program from a nonvolatile storage media 105 to a memory 104 and executes the program. Examples of an execution processing program include an operating system (hereinafter, referred to as an OS) and an application program operating on an OS. The program operating on the CPU 101 acquires operation settings and state information of a communication control IC 102.

The communication control IC 102 receives a transmission request and transmission data from software operating on the CPU 101, and transmits the transmission data to the control network 122 using a PHY 103. The communication control IC 102 transfers data received from the control network 122 via the PHY 103 to the CPU 101, memory 104, and nonvolatile storage media 105 via a bus 106.

Implementation examples of the communication control IC 102 include an IC such as a field programmable gate array (FPGA), a complex programmable logic device (CPLD), an application specific integrated circuit (ASIC), and a gate array. Alternatively, the communication control IC 102 may be integrated with the CPU 101.

The communication control IC 102 may be implemented as an IEEE 802.3 communication device including a MAC layer and a PHY layer, and in this case, a function of the PHY 103 may be included in the communication control IC 102. That is, implementation examples of the communication control IC 102 include a media access control (MAC) chip of IEEE 802.3 standard, a physical layer (PHY) chip, and a composite chip of MAC and PHY. The communication control IC 102 may be included in the CPU 101 or a chipset that controls an information path inside a computer. Although one communication control IC 102 is shown in the configuration in FIG. 2, the number of the communication control ICs 102 may be plural.

The PHY 103 is a transceiver IC that implements a function for communicating with the control network 122. Examples of a communication standard provided by the PHY 103 include a physical layer (PHY) chip of IEEE 802.3. In the configuration shown in FIG. 2, since the PHY 103 and the communication control IC 102 are connected, processing of a media access control (MAC) layer of IEEE 802.3 is included in the communication control IC 102.

However, the configuration may also be a configuration in which an IC that provides a MAC function is arranged between the communication control IC 102 and the PHY 103 or a configuration in which a communication IC in which an IC that provides a MAC function and the PHY 103 are combined is connected to the communication control IC 102. The PHY 103 may be included in the communication control IC 102. In the configuration shown in FIG. 2, one PHY 103 is shown. A quantity relationship between the communication control IC 102 and the PHY 103 may be a relationship in which one or a plurality of PHYS 103 are provided for one communication control IC 102.

The memory 104 is a temporary storage area for operating the CPU 101, and stores an OS, an application program, and the like transferred from the nonvolatile storage media 105. The nonvolatile storage media 105 is a storage medium for information, and is used to store a program for operating an OS, an application, a device driver, and a program for operating the CPU 101, and an execution result of the program. Examples of the nonvolatile storage media 105 include a hard disk drive (HDD), a solid state drive (SSD), and a flash memory. Examples of an external storage medium that can be easily removed include a floppy disk (FD), a CD, a DVD, a Blu-ray (registered trademark), a USB memory, and a compact flash.

The bus 106 connects the CPU 101, the communication control IC 102, the memory 104, and the nonvolatile storage media 105. Examples of the bus 106 include a PCI bus, an ISA bus, a PCI Express bus, an on-chip bus, a system bus, and a memory bus.

### <Functional Configuration of Control Device 120>

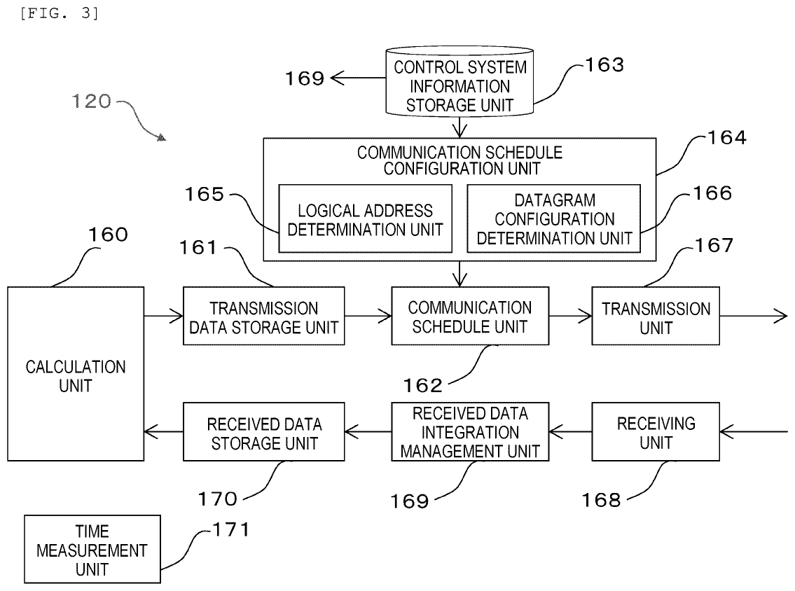

FIG. 3 is a block diagram showing a functional configuration example of the control device 120 shown in FIG. 1. In FIG. 3, a calculation unit 160 performs a control calculation, an information processing calculation, and the like. Examples of such a calculation include a calculation of a control command for processing sensor information received from the control target device 121 and driving the control target device 121 based on a predetermined control rule. Alternatively, examples of such a calculation include filter processing and statistical processing applied to sensor values, and statistical processing for a set of sensor values in a predetermined past period.

Examples of the predetermined control rule include a control engineering theory such as feedback control and feedforward control, and control processing based on AI. Examples of the predetermined control rule include a control method that can change a state depending on past information, such as integral (I) control and control by a state machine. Alternatively, examples of the predetermined control rule include statistical processing such as AI and machine learning processing for the purpose of state management (detection of a failure or dangerous state) of the control target device 121, device management or asset management (version management, update, or the like of software), preventive maintenance, condition based maintenance (CBM), and remaining life prediction.

When the control target device 121 is a mobile object, examples of the predetermined control rule include determination of a moving direction and a target moving position, speed control, acceleration control, stop, and deceleration. When the control target device 121 is an industrial robot arm, examples of the predetermined control rule include a control command to a motor of each articulated joint, control of a front end position of the robot arm, and trajectory control of the robot arm. In this way, since the control target device 121 may be of various types, may be not only an actuator but also a simple sensor, the calculation unit 160 executes the control according to the types of the control target device 121. The calculation unit 160 is, for example, implemented by the CPU 101 or an application operating on the CPU 101.

A transmission data storage unit 161 is a function unit that stores data to be transmitted. The transmission data storage unit 161 stores data generated by the calculation unit 160 when executing predetermined control and information processing for an individual or a plurality of control target devices 121. The stored data is extracted by a communication schedule unit 162. The transmission data storage unit 161 may manage data in units of the communication cycle or the control cycle determined by the control and the information processing executed by the calculation unit 160 and the control target device 121. The transmission data storage unit 161 is implemented, for example, in either the memory 104 or the nonvolatile storage media 105, or both.

The communication schedule unit 162 extracts data from the transmission data storage unit 161 at a predetermined timing, processes the data as necessary, and transfers the data to a transmission unit 167. An example of data processing is shaping the data into a communication format defined by the communication protocol of the control network 122. Examples of the shaping into the communication format include addition of a header and FCS. At this time, information necessary for shaping into the communication format may be stored in the communication schedule unit 162. Such information includes parameters of a header defined by the communication format.

A communication schedule configuration unit 164 notifies the communication schedule unit 162 of a communication schedule, and the communication schedule unit 162 may divide or combine the data extracted from the transmission data storage unit 161 according to the communication schedule. Further, the communication schedule unit 162 may determine parameters such as a header according to the communication schedule configured by the communication schedule configuration unit 164. Therefore, a constituent unit of the data stored in the transmission data storage unit 161 and a constituent unit of the data transferred by the communication schedule unit 162 to the transmission unit 167 may be different.

The communication schedule unit 162 may determine a timing for transferring the shaped data to the transmission unit 167 according to the communication schedule configured by the communication schedule configuration unit 164. The communication schedule unit 162 is implemented by any one or more of the CPU 101 or an application operating on the CPU 101, the communication control IC 102, and the PHY 103.

A control system information storage unit 163 stores information on the control system 123. Specifically, examples of the information to be stored include processing requirements of control processing and information processing executed on the control system 123, and configuration requirements in the control device 120 and the control target device 121. Examples of such requirements include a control cycle, a communication cycle, and an input and output capacity of the control target device 121.

In addition, examples of the processing requirements and the configuration requirements include the number of control devices 120 and control target devices 121, specifications and performance of a computer resource, communication performance, and a configuration of a communication network. Further examples include a frequency, number of cores, a bit width, and an architecture of the CPU 101, a storage capacity and a communication throughput of the memory 104 and the nonvolatile storage media 105, a transfer throughput of the bus 106, and a communication bandwidth and a connection distance of the control network 122. The computer resource such as a CPU, a memory, and a nonvolatile storage media includes both the control device 120 and the control target device 121. When the control network 122 includes a relay device, the control network 122 includes the computer resources and the communication performance of the relay device.

The control system information storage unit 163 may be manually input with information to be stored by the system operator or the like, or may dynamically collect information of the control device 120, the control target device 121, and the control network 122 using information collection software or a predetermined communication protocol. Examples of such a communication protocol include a simple network management protocol (SNMP) and an access to a predetermined register (for example, a register indicating a model number of a slave IC) in EtherCAT. The control system information storage unit 163 is implemented by combining the memory 104 or the nonvolatile storage media 105 with either the CPU 101 or an application operating on the CPU 101, or both.

The communication schedule configuration unit 164 arranges a communication schedule based on the information stored in the control system information storage unit 163, and notifies the communication schedule unit 162 of the schedule. The communication schedule configuration unit 164 cooperates with a logical address determination unit 165 and a datagram configuration determination unit 166 in order to arrange the communication schedule.

The communication schedule configured by the communication schedule configuration unit 164 includes assignment information of an address space of each control target device 121 to a logical address space which is also a virtual area, information of a size of a datagram, information of a logical address and a command of an access destination, and information of a transmission timing and a communication cycle. For example, the communication schedule configuration unit 164 is implemented by any one or more of the CPU 101 or an application operating on the CPU 101, the communication control IC 102, and the PHY 103.

The logical address determination unit 165 determines, based on the information stored in the control system information storage unit 163, an assignment of the address space of each control target device 121 to the logical address space. The assignment of the address space may be executed a plurality of times in response to a request or feedback from the communication schedule configuration unit 164 or the datagram configuration determination unit 166.

A method using a logical address space is a method in which an input and an output of an actuator or a sensor are assigned to a predetermined address space. In the method using the logical address space, any one data area (that is, a physical input and a physical output) of each slave is assigned to a single virtual logical address space. A size and an assignment method of the area can be freely set. The logical address determination unit 165 is implemented by any one or more of the CPU 101 or an application operating on the CPU 101, the communication control IC 102, and the PHY 103.

The datagram configuration determination unit 166 determines, based on the information stored in the control system information storage unit 163 and the assignment of the logical address space determined by the logical address determination unit 165, a configuration of a datagram transmitted by the communication schedule unit 162. Examples of the configuration of the datagram determined by the datagram configuration determination unit 166 include a size of each datagram and parameters on a header (such as a logical address space of an access destination).

The logical address space to which a physical address space of a certain control target device 121 is assigned may be accessed not only by a single datagram but also by datagrams divided into a plurality of datagrams. The datagram configuration determination unit 166 is implemented by any one or more of the CPU 101 or an application operating on the CPU 101, the communication control IC 102, and the PHY 103.

The transmission unit 167 is a transmission function unit, and transmits a packet from the control device 120 to the control network 122. The transmission unit 167 is, for example, implemented by either the communication control IC 102 or the PHY 103, or both.

A receiving unit 168 is a receiving function unit, and receives a packet from the control network 122. The receiving unit 168 may verify a frame check sequence (FCS) and determine validity of the received packet, or may discard a received packet that is determined to be failed. The receiving unit 168 is, for example, implemented by either the communication control IC 102 or the PHY 103, or both.

A received data integration management unit 169 determines a storage position on a received data storage unit 170 for the received data transferred from the receiving unit 168, and transfers the data to the received data storage unit 170. At this time, since the received packet is in a format defined by the communication protocol of the control network 122, the received data integration management unit 169 may extract a necessary header and a necessary data portion. The received data integration management unit 169 is implemented by any one or more of the CPU 101 or an application operating on the CPU 101, the communication control IC 102, and the PHY 103.

The received data storage unit 170 is a function unit that stores received data. The received data storage unit 170 receives a result of execution of predetermined control or information processing from an individual or a plurality of control target devices 121, and stores the result as data. The stored data is extracted by the calculation unit 160. The received data storage unit 170 may manage data in units of the communication cycle or the control cycle determined by the control and the information processing executed by the calculation unit 160 and the control target device 121. The received data storage unit 170 is implemented, for example, in either the memory 104 or the nonvolatile storage media 105, or both.

A time measurement unit 171 is a function unit that manages an elapse of time. The time measurement unit 171 measures an elapsed time of an event in each function unit or between function units shown in FIG. 3, and measures an occurrence time instant of a specific event. A time instant in this case may be an absolute time instant based on a global positioning system (GPS) or the like, a time instant of the control device 120, or a synchronized time instant based on a reference time instant in the control system 123. For example, in EtherCAT, among the control target devices 121, the control target device 121 that supports a distributed clock protocol (DC) and is closest to the control device 120 may be used as the reference time instant.

Events to be measured by the time measurement unit 171 include a predetermined communication frame, a transmission time instant and a reception time instant of a datagram, a data transfer time between function units, and a data processing time or a data retention period within the function unit. Alternatively, the time measurement unit 171 generates an interrupt when a designated time elapses or when a designated time is reached, and notifies other function unit of the interrupt. At this time, the time measurement unit 171 may cyclically generate and notify the interrupt. An implementation example of the time measurement unit 171 includes a time measurement device (a crystal oscillator or a timer device) of the CPU 101 or the communication control IC 102, and the memory 104 or the nonvolatile storage media 105 may be used as a storage unit of a measured time instant.

Although one transmission unit 167 and one receiving unit 168 are shown in FIG. 3, when a plurality of communication control ICs 102 and a plurality of PHYS 103 are provided, a plurality of transmission units 167 and a plurality of receiving units 168 may be provided.

### <Hardware Configuration of Control Target Device 121>

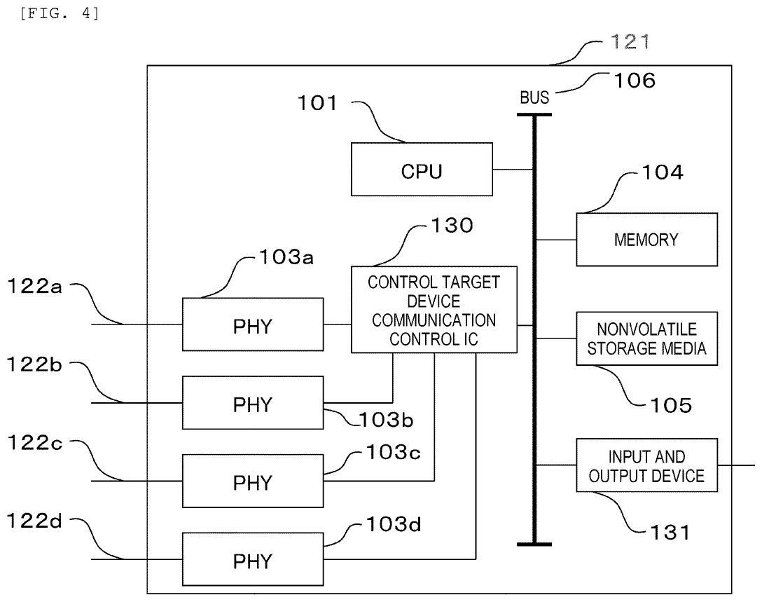

FIG. 4 is a block diagram showing a hardware configuration example of the control target device 121 shown in FIG. 1. Here, the control target device 121 conforming to an EtherCAT specification defined by a communication profile family 12 of IEC 61158 and IEC 61784 Part 2 will be described as an example. However, the control target device 121 is not limited to the EtherCAT specification.

In FIG. 4, the CPU 101 controls a control target device communication control IC 130 via the bus 106. Although not shown, the CPU 101 may control a sensor and an actuator via a peripheral device connected to the CPU 101.

The control target device communication control IC 130 communicates with the control network 122 via a plurality of PHYs 103a to 103d. In the specification, the plurality of PHYs 103a to 103d are collectively referred to as the PHY 103. The control target device communication control IC 130 is a dedicated IC conforming EtherCAT specification defined by a communication profile family 12 of IEC 61158 and IEC 61784 Part 2. The control target device communication control IC 130 may use the nonvolatile storage media 105 when storing and referring to information required for communication.

Although the control target device communication control IC 130 is connected to the CPU 101 via the bus 106, the control target device communication control IC 130 may be directly connected to the CPU 101 using a dedicated bus. One or both of the memory 104 and the nonvolatile storage media 105 dedicated to the control target device communication control IC 130 may be separately provided to store information required for processing of the control target device communication control IC 130.

An input and output device 131 is an input and output interface for acquiring sensor values from sensors constituting the control target device 121 and for controlling actuators constituting the control target device 121. Examples of the input and output device 131 include various actuators such as a motor, various sensors (encoder, temperature sensor, pressure sensor, image sensor, cameras, and the like), various digital input and output ICs and analog input and output ICs, and a driver IC.

Although one signal line from the input and output device 131 is shown in FIG. 4, a plurality of signal lines may be provided according to the configuration of the control target device 121. A plurality of input and output device 131 may be provided. The input and output device 131 may only input information to a connected sensor, may only output information to a connected actuator, or may have both input and output functions. Any one or more of the CPU 101, the memory 104, and the nonvolatile storage media 105 may be included in the control target device communication control IC 130 to form a one-chip communication control IC.

### <Functional Configuration of Control Target Device Communication Control IC 130>

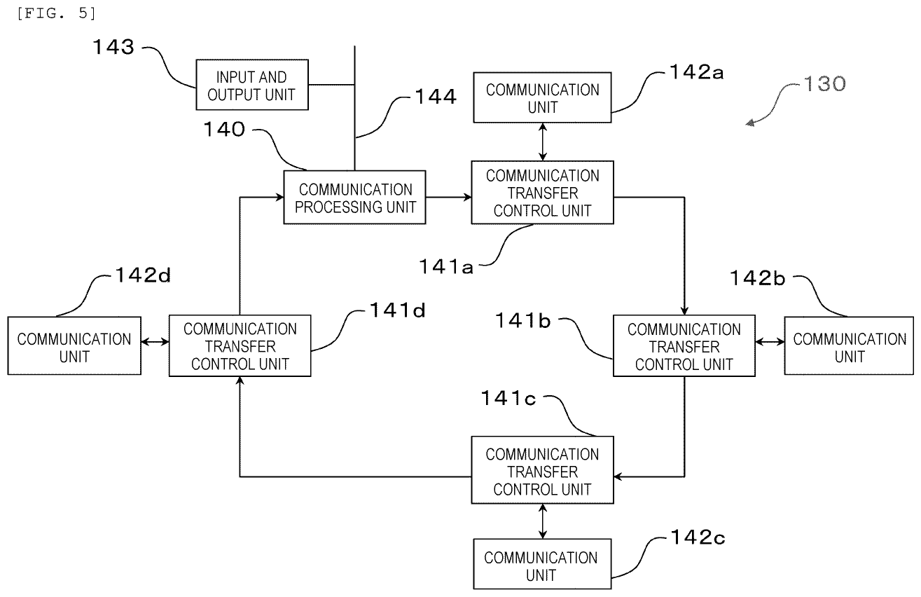

FIG. 5 is a block diagram showing a functional configuration example of the control target device communication control IC 130 shown in FIG. 4. In FIG. 5, four sets of communication port functions are provided by a combination of a plurality of communication transfer control units 141a to 141d and a plurality of communication units 142a to 142d. In the specification, the plurality of communication transfer control units 141a to 141d are collectively referred to as a communication transfer control unit 141, and the plurality of communication units 142a to 142d are collectively referred to as a communication unit 142. The number of communication ports is not limited to four.

A communication processing unit 140 is connected between the communication transfer control unit 141a and the communication transfer control unit 141d related to two communication port functions. For example, the communication processing unit 140 is an IC that executes communication processing conforming to the EtherCAT specification, and is implemented by an EtherCAT processor unit (EPU). The communication processing unit 140 may be connected to other calculation functions and input and output functions.

The communication transfer control unit 141 is a function unit that transfers a received packet to the adjacent communication transfer control unit 141 or to the paired communication unit 142. A transfer direction between the communication transfer control unit 141 is constant in the control target device communication control IC 130, and a packet is transferred in order of the communication transfer control units 141a, 141b, 141c, and 141d. In addition, the communication transfer control unit 141 transfers a packet to the communication unit 142 or transfers a packet to the adjacent communication transfer control unit 141 according to a setting from the communication processing unit 140 and a connection state of a communication path to which the communication unit 142 is connected.

The communication unit 142 is a function unit that is connected to the control network 122 and performs communication according to the communication protocol of the control network 122. Specifically, the communication unit 142 includes the transmission unit 167 and the receiving unit 168 similar to those in the case of FIG. 3. The communication unit 142 is, for example, implemented by either the control target device communication control IC 130 or the PHY 103, or both.

An input and output unit 143 is an input and output function for values from acquiring sensor sensors constituting the control target device 121 and for controlling actuators constituting the control target device 121. The input and output unit 143 is, for example, implemented by the input and output device 131. A bus 144 is a communication line for connecting to any one or more of the CPU 101, the memory 104, the nonvolatile storage media 105, and the input and output device 131, and is, for example, implemented by the bus 106.

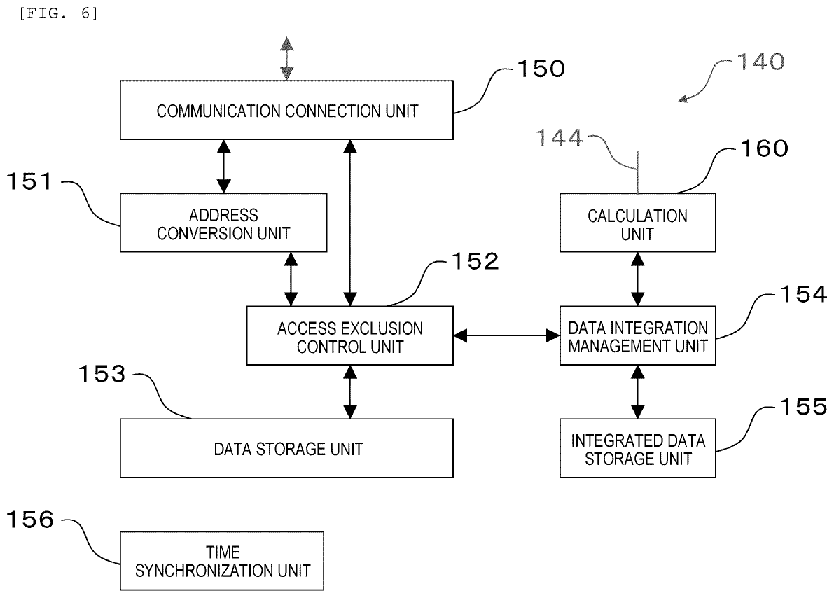

FIG. 6 is a block diagram showing a functional configuration example of the communication processing unit 140 shown in FIG. 5. In FIG. 6, a communication connection unit 150 is a function unit for connecting the communication processing unit 140 and the communication transfer control unit 141. In FIG. 6, one line is shown as the communication line to the external communication transfer control unit 141, but a set of communication lines corresponding to the number of communication transfer control units 141 to be connected is provided. The communication connection unit 150 is internally connected to an address conversion unit 151 and an access exclusion control unit 152. The communication connection unit 150 may directly access a data storage unit 153. The communication connection unit 150 is, for example, implemented by the bus 106.

The address conversion unit 151 is a function unit that converts addresses between two different address systems. For example, in EtherCAT, examples of conversion include conversion between a logical address and a physical address. The address conversion unit 151 is connected to the communication connection unit 150 and the access exclusion control unit 152, and refers to a datagram of EtherCAT in a communication packet transmitted from the communication connection unit 150. In the datagram, the address conversion unit 151 converts logical addresses in the datagram, such as logical memory read (LRD), logical memory write (LWR), and logical memory read write (LRW), which are commands that designate logical addresses, into physical addresses on the data storage unit 153.

A conversion rule between the logical addresses and the physical addresses is set in advance, for example, by communication via the control network 122 or by an application operating on the CPU 101 of the control target device 121. The address conversion unit 151 may directly access the data storage unit 153. The address conversion unit 151 is, for example, implemented by the control target device communication control IC 130.

The access exclusion control unit 152 is connected to the communication connection unit 150, the address conversion unit 151, the data storage unit 153, and a data integration management unit 154, and executes exclusion control between accesses of inputting (writing) to and outputting (reading) from the data storage unit 153. Examples of the access exclusion control unit 152 include a SyncManager in EtherCAT. In particular, the access exclusion control unit 152 integrates and manages a plurality of areas on the data storage unit 153, and automatically converts an input access and an output access into an access to an exclusive area so as to enable a simultaneous input and output access. Accordingly, the simultaneous input and output access to the data storage unit 153 can be executed without delay.

The access exclusion control unit 152 performs the exclusion control not on one entry designated by one address in the data storage unit 153 but on an area including a plurality of entries. The access exclusion control unit 152 may directly access the calculation unit 160. For example, the access exclusion control unit 152 may include a notification unit that interrupts the calculation unit 160 and the data integration management unit 154 for various events including completion of input or output. The access exclusion control unit 152 is, for example, implemented by the control target device communication control IC 130.

The data storage unit 153 is a function unit that stores predetermined settings and data. Examples of information stored in the data storage unit 153 include setting information for an operation of the control target device communication control IC 130 and the communication processing unit 140, state information, and information exchanged between the control device 120 and the control target device 121 (for example, a control command value and sensor information acquired by an input device). The data storage unit 153 is, for example, implemented by any one or more of the control target device communication control IC 130, the memory 104, and the nonvolatile storage media 105.

The data integration management unit 154 is connected to the calculation unit 160, the access exclusion control unit 152, and the integrated data storage unit 155, and integrates and manages, in the integrated data storage unit 155, data acquired from the data storage unit 153 via the access exclusion control unit 152 or data acquired from the calculation unit 160. Further, as the processing in a reverse direction, the data integration management unit 154 outputs the data acquired from the integrated data storage unit 155 to the calculation unit 160 or the data storage unit 153.

The data integration management unit 154 is, for example, implemented by any one or more of the CPU 101, an application operating on the CPU 101, the memory 104, the nonvolatile storage media 105, and the control target device communication control IC 130. When the data integration management unit 154 is implemented by an application on the CPU 101, the data integration management unit 154 may be implemented by an interrupt task or a general task. The data integration management unit 154 includes a delay task activated by interrupt an and a cyclical task. Alternatively, an IC (a bus controller, an ASIC, an FPGA, a CPLD, or the like) (not shown) may be included in the hardware structure of the control target device 121 shown in FIG. 4, and the data integration management unit 154 may be implemented in the IC.

The integrated data storage unit 155 is a function unit that is connected to the data integration management unit 154 and stores data integrated and managed by the data integration management unit 154. The integrated data storage unit 155 is, for example, implemented by either the memory 104 or the nonvolatile storage media 105, or both.

A time synchronization unit 156 executes a time synchronization procedure to synchronize time of the control target device 121 with a predetermined reference time. Examples of a time synchronization method to be executed include a distributed clock protocol of EtherCAT, IEEE 802.1 AS, IEEE 1588, NTP, SNTP, GPS, and a time synchronization method based on wireless communication such as 5G. The time synchronization unit 156 is, for example, implemented by any one or more of the CPU 101 or an application operating on the CPU 101, the PHY 103, and the control target device communication control IC 130.

### <Transmission Procedure of Control Device 120>

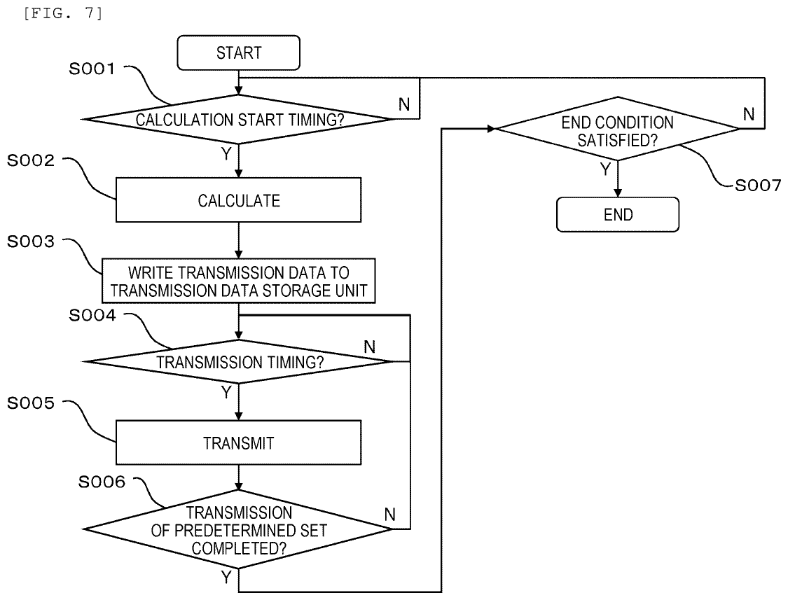

FIG. 7 is a flow diagram showing an example of the transmission procedure executed by the control device 120 shown in FIG. 3. In FIG. 7, first, the calculation unit 160 waits for a start timing of calculation processing of an application (step S001). An execution start timing of the calculation processing may be a timing at which the calculation processing is activated at a predetermined cycle, or may be a timing notified cyclically by the time measurement unit 171. Alternatively, the timing may be based on an interrupt notification from the communication control IC 102 to the CPU 101.

In the function units, any one or more of the transmission data storage unit 161, the communication schedule unit 162, the control system information storage unit 163, the communication schedule configuration unit 164, the transmission unit 167, the receiving unit 168, the received data integration management unit 169, the received data storage unit 170, and the time measurement unit 171 notify an interrupt to the calculation unit 160. In response to this, for example, the calculation unit 160 starts a control application. Examples of an interrupt timing from the communication control IC 102 to the CPU 101 and an interrupt timing from the function unit of FIG. 3 to the calculation unit 160 are as follows.
When the time measurement unit 171 cyclically interrupts at a predetermined cycle, when a predetermined time instant is reached, or when a predetermined period of time elapses
When information stored in the transmission data storage unit 161 is updated and extracted
When the communication schedule is updated by the communication schedule unit 162, or when transfer of communication data is started or completed.
When information stored by the control system information storage unit 163 is updated
When the communication schedule is determined by the communication schedule configuration unit 164 or when notification to the communication schedule unit 162 is completed
When transmission of the communication data by the transmission unit 167 is started or completed
When reception of received data by the receiving unit 168 is started or completed
When extraction of datagrams by the received data integration management unit 169 is started or completed, when the transfer of received data from the receiving unit 168 is started or completed, or when the transfer of data to the received data storage unit 170 is started or completed.
When information stored in the received data storage unit 170 is updated and extracted

Each function unit may generate an interrupt only for predetermined communication data. Examples of limitations for the data include a condition according to a predetermined communication partner (control target device 121), a condition according to a predetermined type of calculation, a condition for a data size (for example, comparison with a predetermined threshold value), and a condition according to a processing timing or a processing time.

When the start timing of the calculation processing in step S001 comes (Y in step S001), the calculation unit 160 executes the calculation processing (step S002). Examples of such calculation processing include calculation of an output command value based on sensor information acquired by the input and output device 131 and the input and output unit 143 of the control target device 121, statistical processing such as AI for applying IoT, and determination of setting information for the control target device 121.

Next, the calculation unit 160 writes the transmission data determined and generated in step S002 to the transmission data storage unit 161 (step S003). Then, the communication schedule unit 162 waits for a transmission timing (step S004). The transmission timing follows the communication schedule determined by the communication schedule configuration unit 164. In step S004, when the transmission timing comes (Y in step S004), the communication schedule unit 162 transmits the transmission data to the control network 122 via the transmission unit 167 (step S005).

Thereafter, the communication schedule unit 162 determines whether the transmission of a predetermined set is completed (step S006). When determining the completion of the transmission of the predetermined set, the communication schedule unit 162 may determine that the transmission is completed by repeating a predetermined number of transmissions, or may determine that the transmission is completed when a total transmission data size is equal to or greater than a predetermined value. Alternatively, the communication schedule unit 162 may determine that the communication is completed when a predetermined communication content is transmitted.

When it is determined in step S006 that the transmission of the predetermined set is completed (Y in step S006), the control device 120 determines whether an end condition is satisfied (step S007). When the end condition is satisfied (Y in step S007), the control device 120 ends the processing. Examples of the end condition include a condition that a predetermined time instant is reached, a condition that a predetermined time elapses, a condition that a predetermined number of transmissions is executed, and a condition that a predetermined set of transmissions reaches a threshold value.

Alternatively, examples of the end condition include that the control system 123 completes the execution of a predetermined control procedure or that predetermined control performance is reached. In addition, a system operator or the like may explicitly instruct to end processing. Alternatively, the end may be determined based on a failure or a change occurring in any one or more of the control device 120, the control target device 121, the control network 122, and the control system 123. For example, occurrence of a serious failure or accident in which it is difficult to continuously execute the control system 123 is exemplified, and safe stop is exemplified.

When it is determined in step S006 that the transmission of the predetermined set is not completed (N in step S006), the processing returns to step S004. In step S007, when the end condition is not satisfied, the processing returns to step S001. Steps S001 to S003 are mainly performed by the calculation unit 160, and steps S004 to S006 are mainly performed by the communication schedule unit 162. Therefore, steps S001 to S003 and steps S004 to S006 may be executed in parallel or concurrently.

### <Reception Procedure of Control Target Device 121>

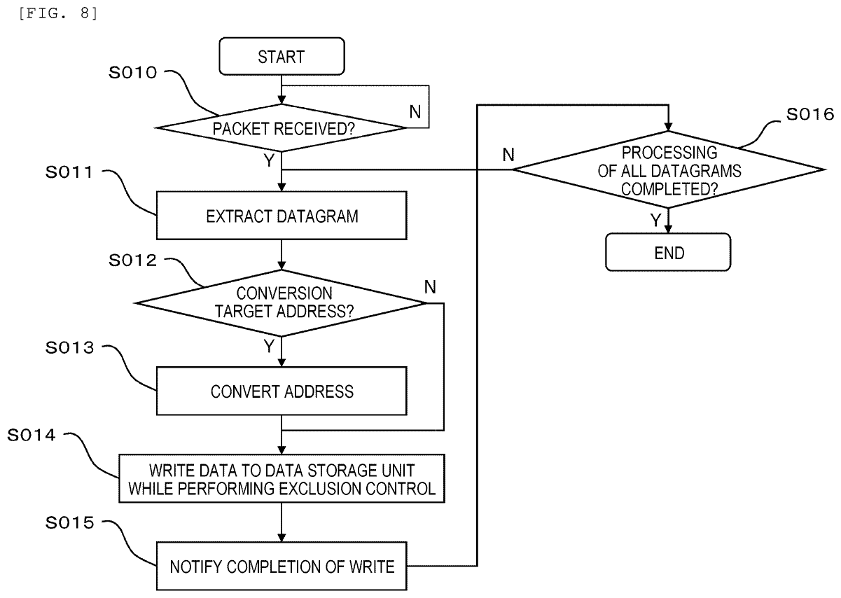

FIG. 8 is a flow diagram showing an example of a reception procedure executed by the control target device 121 in FIGS. 5 and 6. First, the communication unit 142 and the communication transfer control unit 141 wait for reception of a packet via the control network 122 (step S010). When a packet is received in step S010 (Y in step S010), the communication connection unit 150 extracts a datagram constituting the received packet (step S011).

Next, the communication connection unit 150 determines whether an address in a header of the datagram extracted in step S011 is a conversion target address (step S012). The conversion target address is, for example, a logical address. In addition to the logical address, the communication connection unit 150 may independently determine a rule for converting a predetermined address into a physical address on the control target device 121 and determine whether the address is a conversion target address based on whether the address is the target address.

In step S012, when the address in the header of the datagram is the conversion target address (Y in step S012), the address conversion unit 151 converts the address (step S013). Examples of the conversion include conversion from a logical address to a physical address. After step S013 or when the address in the header of the datagram is not the conversion target address in step S012 (N in step S012), the access exclusion control unit 152 writes the data of the received datagram to the data storage unit 153 while performing exclusion control on the access to the data storage unit 153 (step S014).

Then, the access exclusion control unit 152 notifies the data integration management unit 154 of completion of the write to the data storage unit 153 (step S015). The completion of the write may be notified by an interrupt signal or by changing a predetermined register to a predetermined value. In the latter case, the data integration management unit 154 can detect the completion of the write to the data storage unit 153 by the access exclusion control unit 152 by performing a polling access to the register.

Then, the control target device 121 determines whether the processing of all datagrams in the received packet is completed (step S016). At this time, the control target device 121 may determine whether remaining received data is present, or may determine that the processing of all the datagrams is completed if a MORE bit on the header of the datagram in which the write to the data storage unit 153 is completed is 0 (that is, a last datagram).

When it is determined in step S016 that the processing of all datagrams is completed (Y in step S016), the processing ends. When it is determined in step S016 that the processing of all datagrams is not completed (N in step S016), the processing returns to step S011. The flow of FIG. 8 is executed every time a packet is received. The completion of the write in step S015 may be notified not in units of datagrams but in units of packets.

<Integrated Management Procedure during Reception of Control Target Device 121>

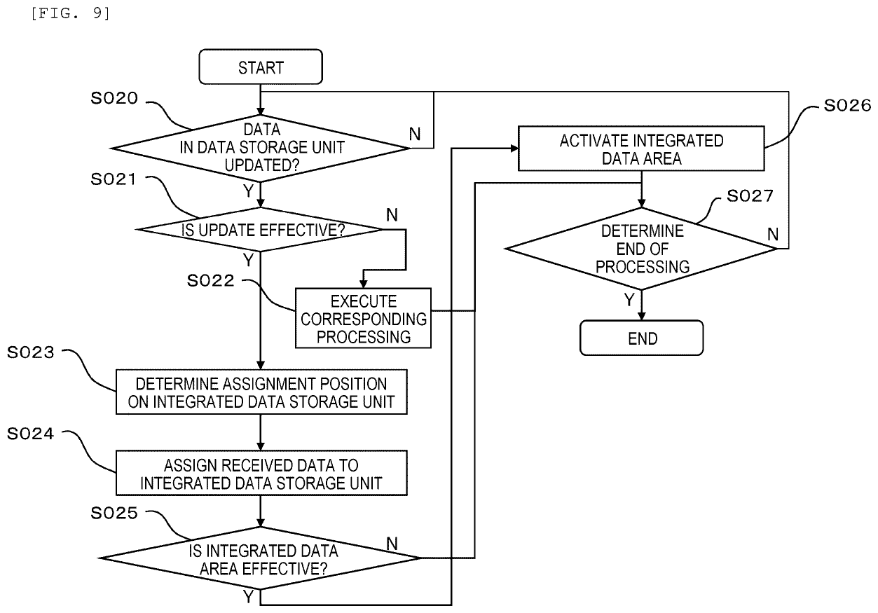

FIG. 9 is a flow diagram showing an example of an integrated management procedure for received data executed by the control target device 121 in FIG. 6. First, the data integration management unit 154 waits until the data in the data storage unit 153 is updated (step S020). When the data in the data storage unit 153 is updated (Y in step S020), the data integration management unit 154 determines whether the update is effective (step S021).

In step S021, the data integration management unit 154 determines whether update data associated with a certain packet is effective based on information on the packet, a packet communication timing, and the like. Specifically, the data integration management unit 154 performs the determination based on, for example, the following determination criteria A1 and A2, or a combination thereof.

Determination criterion A1: When the communication cycle of the control device 120 is constant, whether a reception time instant set in the control target device 121 elapses more than the communication cycle from the previous reception time instant. For example, when the communication cycle of the control device 120 is 100 microseconds and the reception time instant in the control target device 121 is 200 microseconds after the previous reception time instant, it is considered that there is a packet that is not received due to packet loss or the like. On the other hand, when the elapsed time is 100 microseconds, it can be determined that the data can be continuously received and the update data is effective. When there is a jitter in a processing time of the control device 120 or the control target device 121 and a communication latency of the control network 122, a predetermined margin may be added to the threshold value of the elapsed time.

Determination criterion A2: When a sequence number or a transmission time instant in the control device 120 is provided on the received data, it is determined whether the sequence number of the transmission time instant is consistent with a value in the previously received data. For example, when the sequence numbers are not continuous or when a difference between the transmission time instants is more than a predetermined value, the update data is considered to be ineffective, or otherwise, the update data can be determined to be effective. Here, the time instant may be a synchronized time instant using a synchronization protocol such as DC, or may be a time instant in the control device 120.

When it is determined in step S021 that the update data is effective (Y in step S021), the data integration management unit 154 determines an assignment position on the integrated data storage unit 155 (step S023). Then, the data integration management unit 154 assigns the received data to the position determined in step S023 on the integrated data storage unit 155 (step S024).

Then, the data integration management unit 154 determines whether an integrated data area of the integrated data storage unit 155, in other words, control data on the integrated data area, is effective (step S025). At this time, the data integration management unit 154 may determine whether the integrated data area is effective based on whether the number of datagrams or the number of repetitions of reception of packets is equal to or greater than a predetermined value, or may determine whether a total received data size is equal to or greater than a predetermined value. Alternatively, the data integration management unit 154 may determine that the communication is completed when the predetermined communication content is received. In step S025, when the integrated data area is effective (Y in step S025), the data integration management unit 154 activates the integrated data area of the integrated data storage unit 155 (step S026).

In step S021, when it is determined that the update data is ineffective (N in step S021), the data integration management unit 154 executes corresponding processing (step S022). Examples of the corresponding processing include notifying the calculation unit 160, the access exclusion control unit 152, and the communication connection unit 150 (connection with the data integration management unit 154 is not shown) of the control target device 121 that the update data is ineffective. Examples of the notification include an interrupt.

Alternatively, examples of the corresponding processing include deactivating an area that is already received and is assigned to the integrated data storage unit 155 or deactivating the area even when data scheduled to be received in the future is received. That is, the determination criterion of whether the update data in step S021 is effective includes presence or absence of the deactivating processing in step S022. Specifically, when the next packet is received after the integrated data storage unit 155 is updated based on the first packet, and the update of the data storage unit 153 associated with the next packet is ineffective, the update based on the first packet is also ineffective.

In addition, the deactivating processing itself may be deactivated after a predetermined number of packets or datagrams are received, or after a predetermined time instant or period elapses. Such processing is also included in the corresponding processing in step S022 and each subsequent procedure. Alternatively, the deactivating processing may be executed independently of or concurrently with the procedure shown in FIG. 9.

After step S026 and S022, or when the integrated data area is ineffective in step S025 (N in step S025), the control target device 121 determines the end of the processing (step S027). The determination of the end condition is similar to step S007 in FIG. 7. In addition, the end may be determined based on a processing result in step S022. For example, it may be determined that the processing ends when the number of times of deactivating is more than a predetermined value.

The corresponding processing (such as deactivation of the area of the integrated data storage unit 155) in step S022 is executed with the data update in step S020 as a starting point. However, in consideration of the possibility of a communication failure in the control network 122, the corresponding processing may be executed after a predetermined elapsed time (time-out) from an event such as immediately preceding data update, packet reception, or an assignment to an area of the integrated data storage unit 155.

In step S023, the data integration management unit 154 may determine the assignment position in the order of reception or may determine the assignment position based on the reception time instant. For example, by sharing the communication cycle, in other words, the communication timing of the packet between the control device 120 and the control target device 121 in advance, the control target device 121 can determine which cycle communication occurs based on the reception time instant. At this time, a start time instant may be shared between the control device 120 and the control target device 121, or a time instant at which the control target device 121 first receives after the start of the processing may be set as the start time instant and stored in the control target device 121. Examples of the information sharing between the control device 120 and the control target device 121 include a use of mailbox communication.

Alternatively, a transmission source of data, in this case, for example, the control device 120 may store information designating what number the communication is and/or the assignment position in the communication data in advance. Information such as a header may be used, or a data area on a packet or a datagram may be used. Alternatively, a transmission source of data may store, in the data area on the packet or the datagram in advance, address information indicating the assignment position on the integrated data storage unit 155. In this case, when a physical address of a built-in RAM of an EtherCAT slave is 16 bits (64 KB) and an effect of using a space larger than the built-in RAM as the integrated data area is expected, a bit width of the address needs to be larger than 16 bits.

When the integrated data area of the integrated data storage unit 155 is effective in step S025, the data integration management unit 154 may notify the calculation unit 160 that the integrated data area is activated by an interrupt or the like, or may transfer the effective data to the calculation unit 160. Therefore, the integrated data storage unit 155 may have a plurality of integrated data areas for the received data. Accordingly, in step S025, the integrated data area can be switched before and after the integrated data area is determined to be effective.

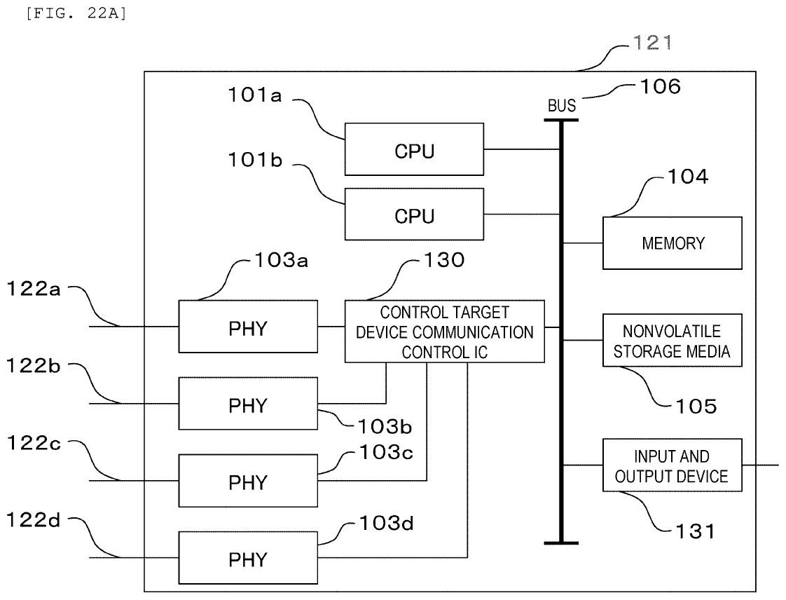

The plurality of integrated data areas may be implemented by, for example, a ring buffer. FIG. 21 is a schematic view showing a configuration example of the integrated data storage unit 155 in FIG. 6. As shown in FIG. 21, when the integrated data storage unit 155 is implemented by a ring buffer, the data integration management unit 154 manages a write position and a read position for a plurality of integrated data areas.

In steps S025 and S026, the data integration management unit 154 may activate only partial areas and deactivate unreceived areas, instead of activating the area only after all pieces of necessary data are collected. In this case, for example, when the calculation unit 160 accesses an unreceived area, an error occurs.

### <Transmission Operation of Control Target Device 121>

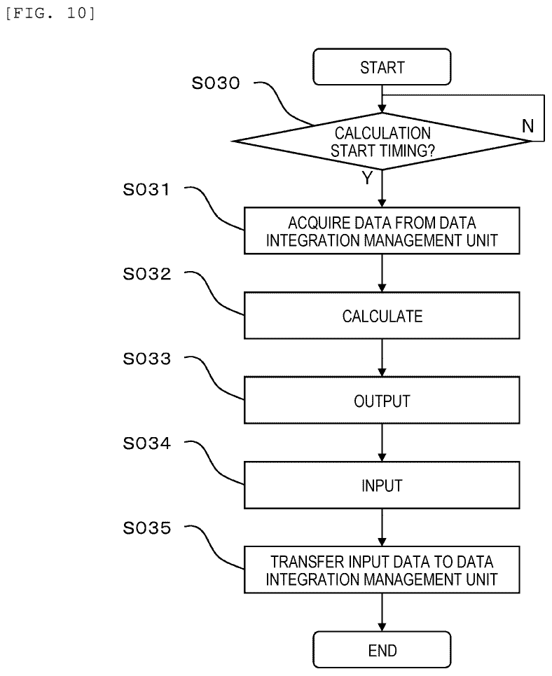

FIG. 10 is a flow diagram showing an example of a transmission procedure executed by the control target device 121 in FIGS. 5 and 6. In FIG. 10, first, the calculation unit 160 waits for a start timing of calculation processing of an application (step S030). An execution start timing of the calculation processing may be a timing at which the calculation processing is activated at a predetermined cycle, or may be a timing notified cyclically by the time synchronization unit 156, a timer (not shown), or the like. Alternatively, the timing may be a timing activated by a notification from each function unit to the calculation unit 160 shown in FIG. 6 (connection between a part of function units and the calculation unit 160 is not shown).

A notification timing from the function unit shown in FIG. 6 to the calculation unit 160 is as follows.
When a packet is received, transmitted, or transferred by the communication connection unit 150
When address conversion by the address conversion unit 151 is started or completed
When the access exclusion control unit 152 writes data to or reads data from the data storage unit 153, or when the access exclusion control unit 152 starts or completes data transfer with the data integration management unit 154
When updating or extracting data stored in the data storage unit 153
When the data integration management unit 154 starts or completes data transfer with the access exclusion control unit 152 or the calculation unit 160
When the data integration management unit 154 writes data to the integrated data storage unit 155, or reads data from the integrated data storage unit 155, or when an integrated data area in the integrated data storage unit 155 is activated or deactivated
When the time synchronization unit 156 interrupts at a predetermined cycle, when a predetermined time instant is reached, or when a predetermined period elapses

Each of the function units shown in FIG. 6 may generate a notification by restricting the data to predetermined data. Examples of restriction for the data include a condition according to a predetermined type of calculation, a condition for a data size (for example, comparison with a predetermined threshold value), and a condition according to a processing timing or a processing time.

When a start timing of the calculation processing in step S030 comes (Y in step S030), the calculation unit 160 acquires data from the integrated data storage unit 155 via the data integration management unit 154 (step S031). Next, the calculation unit 160 executes the calculation processing based on the acquired data (step S032). When an output value is calculated by the calculation processing, the calculation unit 160 outputs the output value (step S033). The output value is used, for example, to control an actuator or the like.

Next, the calculation unit 160 acquires, via the bus 144, input information from the input and output unit 143 shown in FIG. 5 corresponding to the input and output device 131 such as a sensor (step S034). The calculation unit 160 transfers the acquired input information to the data integration management unit 154, and the data integration management unit 154 writes the transferred data in the integrated data storage unit 155 (step S035). Then, the processing ends.

In FIG. 10, a series of processing are sequentially performed, and some or a plurality of steps S031, S032, S033, S034, and S035 may be performed in parallel. When the control target device 121 does not include an output device such as an actuator, step S033 may not be executed.

Similarly, when the control target device 121 does not include an input device such as a sensor, step S034 may not be executed.

### <Integrated Management Procedure During Transmission of Control Target Device 121>

FIG. 11 is a flow diagram showing an example of an integrated management procedure for transmission data executed by the control target device 121 shown in FIG. 6. In FIG. 11, first, the data integration management unit 154 waits until the data in the integrated data storage unit 155 is updated (step S040). When the data in the integrated data storage unit 155 is updated (Y in step S040), the data integration management unit 154 divides the data (step S041).

Next, the data integration management unit 154 waits for a transfer timing of the data divided in step S041 (step S042). When the transfer timing in step S042 comes (Y in step S042), the data integration management unit 154 transfers the divided data to the access exclusion control unit 152 (step S043).

Then, the data integration management unit 154 determines whether the transfer of the divided data of a predetermined set is completed (step S044). When it is determined in step S044 that the transfer of the divided data of the predetermined set is completed (Y in step S044), the control target device 121 determines whether an end condition is satisfied (step S045). When the end condition is satisfied (Y in step S045), the processing ends. The determination of the end condition is similar to step S007 in FIG. 7.

The data transferred to the access exclusion control unit 152 in step 043 can be acquired by the control device 120 through communication based on a read command from the control device 120. When it is determined in step S044 that the transfer of the divided data of the predetermined set is not completed (N in step S044), the processing returns to step S042. When the end condition is not satisfied in step S045 (N in step S045), the processing returns to step S040.

After step S040, the data integration management unit 154 may determine whether the update data to the integrated data storage unit 155 by the calculation unit 160 is effective by monitoring and comparing the data transfer timing and the like. When the data is ineffective, the data integration management unit 154 may issue a notification to the outside, such as an interrupt notification to the calculation unit 160 or a notification to the control device 120.

Examples of the division of the data in step S041 include an equal division into a number determined in advance. The data integration management unit 154 may associate an attribute of each piece of divided data with each piece of data divided in step S041. Examples of such an attribute include a position of the divided data in the entire data, a size of the divided data, an identifier for identifying the divided data, and a sequence number. In addition, an area may be provided on the divided data to store the attribute.

In addition, in steps S043 and S044, the data integration management unit 154 may notify the calculation unit 160 of start of data transfer, completion of data transfer, and the completion of a predetermined set using a method such as an interrupt.

### <Reception Operation of Control Device 120>

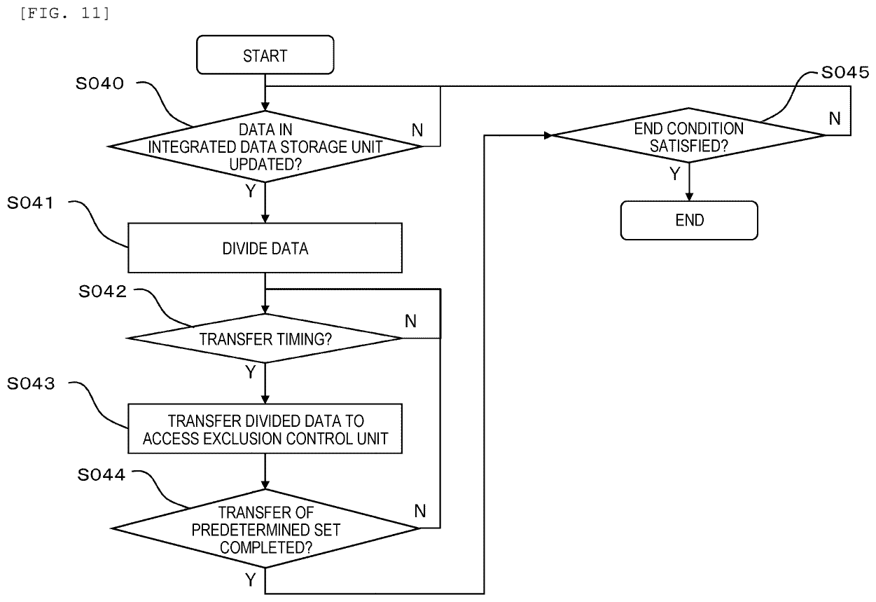

FIG. 12 is a flow diagram showing an example of a reception procedure executed by the control device 120 in FIG. 3. In FIG. 12, first, the receiving unit 168 waits for reception of a packet (step S050). When a packet is received in step S050 (Y in step S050), the received data integration management unit 169 determines whether the received data is effective (step S051). The received data integration management unit 169 determines whether the received data is effective based on, for example, any one of the following determination criteria B1 to B5 or a combination of a plurality of determination criteria.

Determination criterion B1: When the communication cycle of the control device 120 is constant, whether a reception time instant set in the control device 120 elapses more than the communication cycle from the previous reception time instant. For example, when the communication cycle of the control device 120 is 100 microseconds and the reception time instant in the control device 120 is 200 microseconds after the previous reception time instant, it is considered that there is a packet that is not received due to packet loss or the like. On the other hand, when the elapsed time is 100 microseconds, it can be determined that the data can be continuously received and the received data is effective. When there is a jitter in a processing time of the control device 120 or the control target device 121 and a communication latency of the control network 122, a predetermined margin may be added to the threshold value of the elapsed time.

Determination criterion B2: When a sequence number or a transmission time instant in the control device 120 is provided on the received data, it is determined whether the sequence number or the transmission time instant matches a value in the previously received data. For example, when the sequence numbers are not continuous or when a difference between the transmission time instants is more than a predetermined value, the received data is considered to be ineffective, or otherwise, the received data can be determined to be effective.

Determination criterion B3: when recording a transmission time instant in the control device 120, whether the transmission time instant matches a reception time instant of the received data. When a difference between the reception time instant and the transmission time instant (that is, a communication latency) is more than a predetermined value, the received data is considered to be ineffective, or otherwise, the received data can be determined to be effective. When a real-time network with high time determinability is used as the control network 122, a predetermined value for determining effectiveness of the received data can be determined from a specification of the control network 122. The transmission time instant may be stored in a packet.

Determination criterion B4: Whether an error is detected based on an error detection code on the packet. Examples of the error detection code include a cyclic redundancy check (CRC).

Determination criterion B5: Whether a value at a predetermined position on a packet is a predetermined value. In this case, when a value at the predetermined position on the packet is the predetermined value, a method for determining that the data is effective may be used, or conversely, a method for determining that the data is ineffective may be used. For example, the determination may be performed using data updated by the control target device 121 or an IRQ or WKC value of a datagram header of EtherCAT.

When it is determined that the received data is effective (Y in step S051), the received data integration management unit 169 determines an assignment position of the received data in the received data storage unit 170 (step S052). Then, the received data integration management unit 169 assigns the received data to the position determined in step S052 (step S053). Then, the received data integration management unit 169 determines whether a set of received data is effective (step S054). When it is determined in step S054 that the set of received data is effective (Y in step S054), the received data integration management unit 169 activates the received data in the received data storage unit 170 (step S055).

On the other hand, in step S051, when it is determined that the received data is ineffective (N in step S051), the received data integration management unit 169 executes corresponding processing (step S057). Examples of the corresponding processing include a presentation to the outside, including a notification such as an interrupt to the calculation unit 160 of the control device 120.

Alternatively, examples of the corresponding processing include deactivating an area that is already received and is assigned to the received data storage unit 170 or deactivating the area even when data scheduled to be received in the future is received. That is, the determination criterion of whether the received data in step S051 is effective includes presence or absence of the deactivating processing in step S057. The deactivating processing itself may be deactivated after a predetermined number of packets or datagrams are received, or after a predetermined time instant or period elapses. Such processing is also included in the corresponding processing in step S057 and each subsequent procedure. Alternatively, the deactivating processing may be executed independently of or concurrently with the procedure shown in FIG. 12.

Further, after the processing of step S055, after the processing of step S057, or when it is determined in step S054 that the received data set is ineffective (N in step S054), the control device 120 determines whether an end condition is satisfied (step S056). When the end condition is satisfied (Y in step S056), the processing ends. The determination of the end condition is similar to step S027 in FIG. 9. In addition, the end may be determined based on a processing result in step S057. For example, it may be determined that the processing ends when the number of times of deactivating is more than a predetermined value.

In step S052, the received data integration management unit 169 may determine the assignment position in the order of reception or may determine the assignment position based on the reception time instant. Since the control device 120 grasps the start time instant and the communication cycle, it can determine which cycle communication occurs. Alternatively, a transmission source of the data, in this case, for example, the control device 120 or the control target device 121 may store information designating what number the communication is and/or the assignment position in the communication data. In this case, information such as a header may be used, or a packet or a data area on a datagram may be used.

Alternatively, a transmission source of data may store, in the data area on the packet or the datagram, address information indicating the assignment position on the received data storage unit 170. In this case, when a physical address of a built-in RAM of an EtherCAT slave is 16 bits (64 KB) and an effect of using a space larger than the built-in RAM as the integrated data area is expected, a bit width of the address needs to be larger than 16 bits.

Since the information indicating the assignment position on the received data storage unit 170 is originally the information determined by the control device 120, an identifier of the packet and the assignment position on the received data storage unit 170 may be stored in association with each other without being stored on the packet. In this case, the received data integration management unit 169 may determine the assignment position on the received data storage unit 170 based on the identifier of the received packet. The method can also be applied to the data integration management unit 154 described in FIG. 9.

The corresponding processing (such as deactivation of the area of the received data storage unit 170) in step S057 is executed with the packet reception in step S050 as a starting point. However, in consideration of the possibility of a communication failure in the control network 122, the corresponding processing may be executed after a predetermined elapsed time (time-out) from an event such as immediately preceding packet reception, an assignment of received data, and activation of the received data set.

### <Operation Examples of Communication Schedule Unit 162 and Communication Schedule Configuration Unit 164>

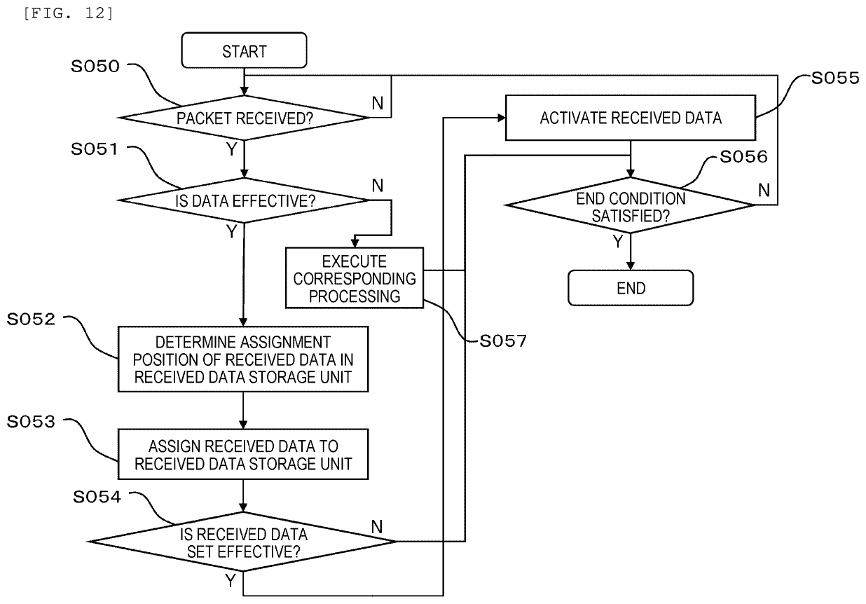

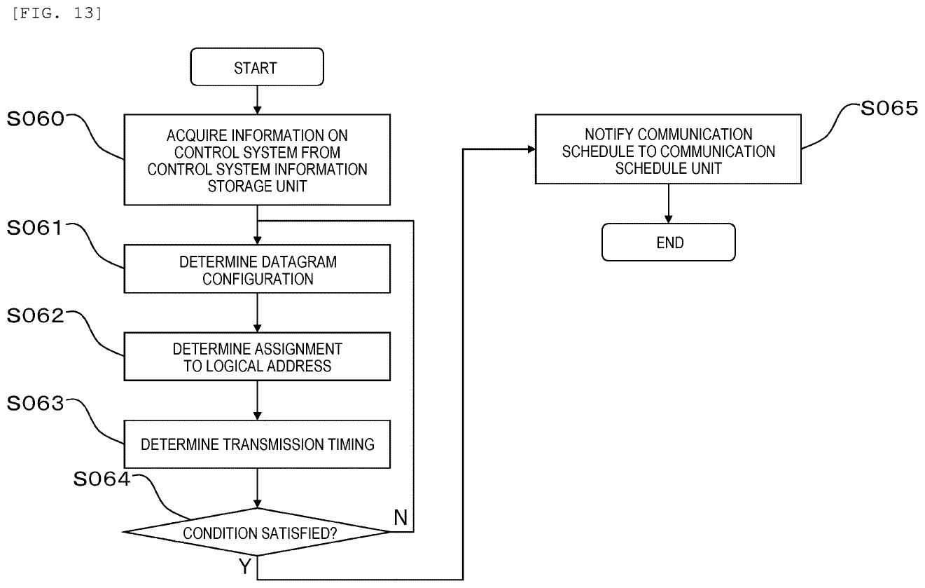

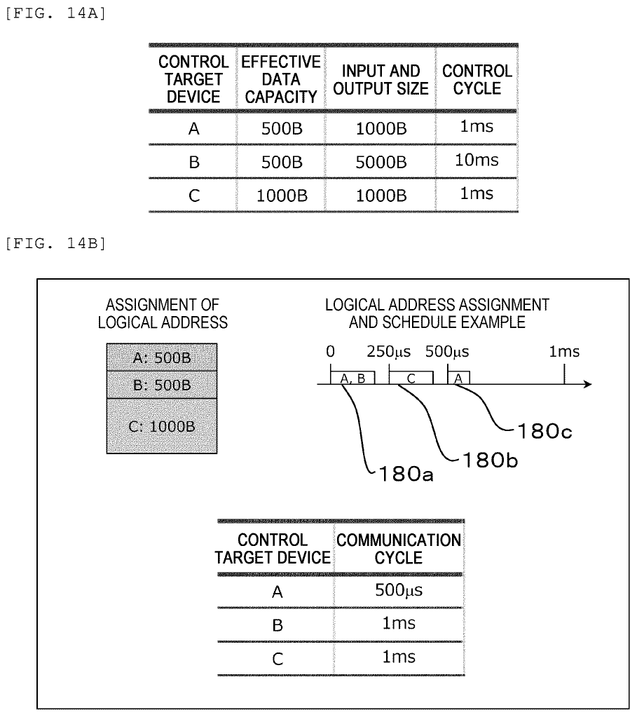

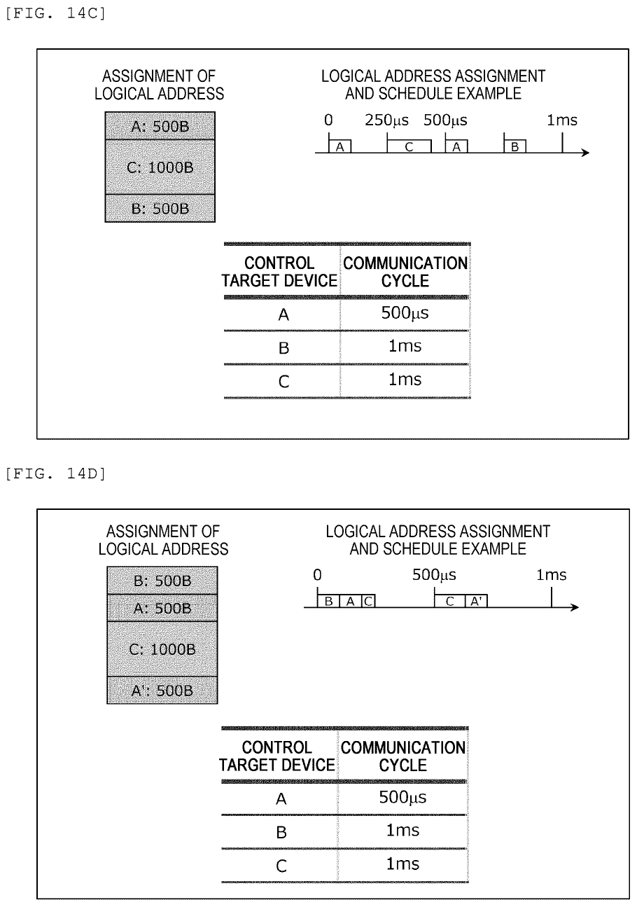

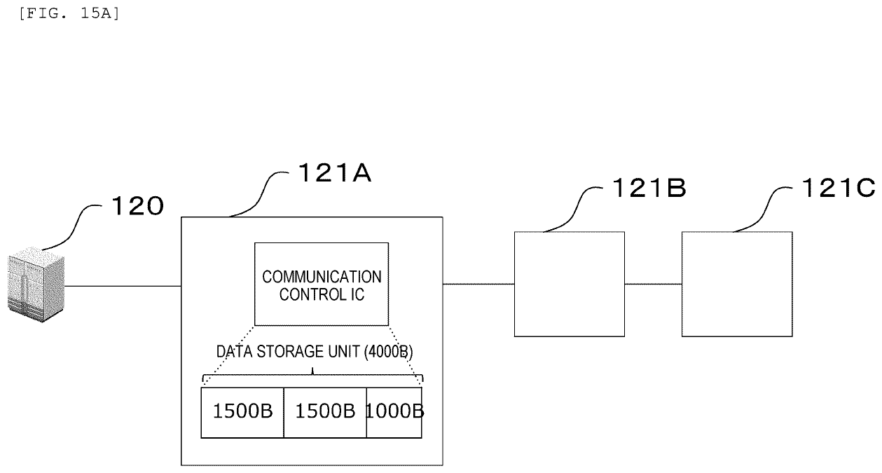

FIG. 13 is a flow diagram showing an example of a procedure in which the communication schedule configuration unit 164 determines the communication schedule in FIG. 3. FIGS. 14A, 14B, 14C, and 14D are schematic views showing a specific example of the communication schedule determined by the flow shown in FIG. 13. In FIG. 13, first, the communication schedule configuration unit 164 acquires information related to the control system 123 from the control system information storage unit 163 (step S060). As shown in FIG. 14A, the acquired information includes an effective data capacity, an input and output size, and a control cycle in the data storage unit 153 of each control target device 121.

The effective data capacity indicates a data size that can be assigned to control communication in the data storage unit 153. In the case of EtherCAT, the capacity of the built-in RAM that can be assigned to the processing data communication, which corresponds the control to communication, is one-third of the capacity assigned to the mailbox communication and the like, if any, plus the capacity is subtracted to allow SyncManager that manages the exclusion control of the built-in RAM to function. For example, when the data storage unit 153 (built-in RAM) is 8 kB and 2 kB is assigned to the mailbox communication, the effective data capacity is (8 kB−2 kB)/3=2 kB.

The input and output size is a data size to be updated by the control device 120 per control cycle. Although input and output are used here, only input or only output may be used. In addition, when an LRW command of EtherCAT is used, since the input (read from the control device 120) and the output (write from the control device 120) can be simultaneously communicated, it is not necessary to separately measure an input size and an output size and sum them. For example, even when the input size (for example, a sensor value) and the output size (for example, a command value) each require 2 kB, the input and output size may be 2 kB instead of 4 kB.

Here, a case in which communication is performed using the LRW command is taken as an example. However, the input and the output may be communicated by an LRD command and an LWR command, respectively. The input size and the output size may not be equal. In this case, the input and the output may be communicated by the LRD command and the LWR command, respectively, or the LRW may be used to match the smaller size, and a surplus may be communicated using either the LRD command (when the input size is large) or the LWR command (when the output size is large).

Further, the information that the communication schedule configuration unit 164 acquires from the control system information storage unit 163 includes constraints and requirements regarding the number of fieldbus memory management units (FMMUs) installed in each control target device 121 and the number of FMMUs used. The constraints and requests on the number of uses may be set for each control target device 121. Similar information may also be included for SyncManager.

After execution of step S060, the datagram configuration determination unit 166 determines a configuration of a datagram to be transmitted from the control device 120 to the control target device 121 (step S061). For example, the number of datagrams in the control cycle can be calculated by dividing the input and output size by the effective data capacity. Further, if the communication is performed at equal intervals, the communication cycle can be calculated based on the number of datagrams.

In the case of FIG. 14A, the number of datagrams and the communication cycle of each control target device 121 are obtained by the following (A) to (C).
(A) In the case of a control target device 121A Number of datagrams: 1000B/500B=2 Communication cycle: 1 ms/2=500 μs
(B) In the case of a control target device 121B Number of datagrams: 5000B/500B=10 Communication cycle: 10 ms/10=1 ms
(C) In the case of a control target device 121C Number of datagrams: 1000B/1000B=1 Communication cycle: 1 ms/1=1 ms

The datagram configuration determination unit 166 determines the configuration of the datagram based on the calculated number of datagrams in the control cycle and the communication cycle. At this time, it is necessary to consider a maximum allowable data size that can be communicated, which is defined by the protocol of the control network 122. For example, in the IEEE 802.3, the maximum allowable data size is 1500 bytes (excluding the header and the FCS), and in the case of EtherCAT, one datagram is 1486 bytes. In the case of EtherCAT, an overhead of the header or the like increases as the number of datagrams increases, and thus the maximum allowable data size per datagram and the total number of datagrams decreases.

In the example shown in FIG. 14A, since the effective data capacity of each of the control target devices 121A, 121B, and 121C is equal to or smaller than the maximum allowable data size of EtherCAT, the datagrams may be configured individually. Alternatively, even if the control target devices 121A and 121B are combined, the total is (500B+500B=1000B), which is less than the maximum allowable data size of EtherCAT, and therefore the control target devices 121A and 121B can be combined. On the other hand, when the control target devices 121A and 121C are combined, (500B+1000B=1500B) is obtained, which exceeds the maximum allowable data size of EtherCAT, and therefore the control target devices 121A and 121C cannot be combined. The same applies to the combination of the control target devices 121B and 121C.

As described above, the datagram configuration determination unit 166 determines the configuration of the datagram in consideration of the effective data capacity and the maximum allowable data size in the control network 122 (an allowable size of a communication packet and an allowable size in datagram units). In this case, the communication cycle or the number of partial areas divided when integrating data in the data integration management unit 154 may be different for each control target device 121. In the above example, the number of partial areas divided is 2 for the control target device 121A, 10 for the control target device 121B, and 1 for the control target device 121C.

Next, in consideration of the datagram configuration determined in step S061, the logical address determination unit 165 determines an assignment of the data storage unit 153 of each control target device 121 to a logical address (step S062). For example, when the datagrams communicating with the control target devices 121A, 121B, and 121C shown in FIG. 14A are individually configured, there are no constraints on the assignment to the logical addresses, and thus the assignment can be freely performed. As an example, the logical address determination unit 165 may perform the assignment of the logical address as shown in FIG. 14C.

On the other hand, when the control target devices 121A and 121B are coupled, the data storage units 153 of the control target devices 121A and 121B need to be assigned to continuous areas. In this case, for example, the logical address determination unit 165 may perform the assignment of the logical address as shown in FIG. 14B.

Next, the communication schedule configuration unit 164 determines a transmission timing of each datagram (step S063). Examples of the transmission timing determined by the communication schedule configuration unit 164 include a communication cycle of each control target device 121 and an offset of the transmission timing. The transmission timing is determined to satisfy requirements such as the control cycle, the input and output size, and the communication cycle which can be calculated in step S061.

FIGS. 14B and 14C show an example of the transmission timings determined in step S063. In FIGS. 14B and 14C, the communication cycles of the control target devices 121A, 121B, and 121C are determined to be 500 μs, 1 ms, and 1 ms, respectively. The offset of the transmission timing for the control target device 121C is determined to be 250 μs. In the case of FIG. 14C, the offset of the transmission timing is also provided for the control target device 121B.

As shown in FIGS. 14B and 14C, for example, when 1 ms is a unit time, the number of datagrams of the control target device 121A per unit time is two, and the size of each datagram is 500 bytes. The number of datagrams of the control target device 121B per unit time is one, and the size of the datagram is 500 bytes. The number of datagrams of the control target device 121C per unit time is one, and the size of the datagram is 1000 bytes.

After step 063, the communication schedule configuration unit 164 determines whether a predetermined condition is satisfied (step S064). The determination may be made based on, for example, whether each or a plurality of steps S061 to S063 is executed a predetermined number of times. Alternatively, the determination may be made based on whether a request value is satisfied for any one or more of the number of datagrams, the number of packets, and a communication bandwidth utilization rate per predetermined unit time.

Examples of the predetermined unit time include a maximum communication cycle calculated in step S061. In the case of FIGS. 14B and 14C, the communication cycle of the control target devices 121B and 121C is 1 ms, which is a maximum value among the control target devices 121A, 121B, and 121C, and therefore the communication cycle is regarded as the unit time.

In addition, the request values of the number of datagrams, the number of packets, and the communication bandwidth utilization rate may be stored in the control system information storage unit 163 in advance. The communication bandwidth utilization rate is a ratio of a data communication latency per unit time in the control network 122. The data communication latency includes, for example, a communication latency of a packet (communication frame) itself, as well as a communication latency of a preamble, a start frame delimiter (SFD), an FCS, and an interframe gap (IFG).

Alternatively, in step S064, the communication schedule configuration unit 164 may determine whether the number of datagrams and the number of packets are ideal values. For example, the ideal value of packets is the maximum value of either the required minimum number of packets based on the datagram division or the required minimum number of packets based on the maximum allowable size. In this case, the maximum communication cycle calculated in step S061 is set as the unit time.

For example, in FIGS. 14B and 14C, the unit time which is the maximum communication cycle is 1 ms, and the number of datagrams required for the control target device 121A per unit time is two. On the other hand, the number of datagrams required per unit time for each of the control target devices 121B and 121C is one. Therefore, the required minimum number of packets based on datagram division is determined by the control target device 121A to be two.

On the other hand, when a sum of the effective data capacity per unit time in the control target devices 121A, 121B, and 121C is divided by the maximum allowable size of a datagram of EtherCAT and rounded up to an integer value, then Ceil ((500B×2+500B+1000B)/1486B)=2, where Ceil( ) is a ceiling function. As a result, since both the required minimum number of packets based on the datagram division and the required minimum number of packets based on the maximum allowable size are two, the maximum number of packets is two. The ideal value of datagrams is the same as the ideal value of packets. Therefore, the ideal value of datagrams is two.

FIG. 14D shows an example of a datagram configuration, an assignment of a logical address, and a transmission timing determined to minimize the number of packets and the number of datagrams. In the example, an access to the control target device 121C is divided into a plurality of packets, and an access to the divided control target device 121C and an access to the control target device 121A are continuous. Therefore, the data storage unit 153 of the control target device 121A is assigned to two logical addresses (A, A′).

As described above, the communication schedule configuration unit 164 determines the datagram configuration, the assignment of the logical address, and the transmission timing based on the effective data capacity, the input and output size, and the control cycle.

According to such a configuration, the number of packets and the number of datagrams can be minimized, and an overhead in communication associated with a header and an IFG can be minimized. Accordingly, other types of communication such as a setting and a state acquisition signal can be executed by utilizing the surplus communication bandwidth, and can be utilized for maintenance and diagnosis by visualization of the control target device 121 and the control system 123 and utilization of IoT. Therefore, the operation of the control system 123 can be leveled up, and performance and an operating rate of the control system can be improved.

As one solution of the above-described communication schedule determination method, the area of the data storage unit 153 of each control target device 121 is assigned to a continuous logical address space. In addition, the data storage unit 153 of the control target device 121 that transmits a plurality of datagrams per unit time (the maximum value in the maximum communication cycle of each control target device 121 calculated in step S061) may be assigned to a plurality of logical addresses. At this time, as in the case of the control target device 121A in FIG. 14D, the data storage unit 153 of the same control target device 121 is not assigned to the continuous logical addresses.

The method is used in a case in which the datagram cannot be stored in a single datagram when the datagram is transmitted in a state in which each control target device 121 is continuously assigned to the logical address as in the case of FIG. 14D. Meanwhile, in FIG. 14D, when the effective data capacity of the control target device 121C is as small as 500B, the number of packets and the number of datagrams can be minimized by assigning the logical addresses in the order of the control target devices 121B, 121A, and 121C.

Specifically, the LRW command for accessing the control target devices 121B and 121A in the first datagram and the LRW command for accessing the control target devices 121A and 121C in the next datagram every 500 μs may be used. In this case, since a plurality of pieces of data to be transmitted to the control target device 121A can each be stored in a single datagram, there is no need to assign the control target device 121A to a plurality of logical addresses.

In the case of FIG. 14D, in the control target device 121A, two FMMUs are used in order to assign a plurality of logical addresses, and four FMMUs are used in the case of both input and output. If the constraint on the use of the FMMU is one, the assignment of the data storage unit 153 of the control target device 121A to the logical address may be performed in one location.

In this way, the number of datagrams is three. That is, the second packet in FIG. 14D is made up of two datagrams because the logical addresses of the control target device 121A and the divided control target device 121C are not continuous. On the other hand, since the number of communication packets remains at two, the overhead to be increased can be limited to the size of one datagram, specifically, to the size of the datagram header and the WKC. Specific examples thereof include a method for setting a priority relationship and a weight between a communication requirement and a requirement of a resource (FMMU) in the communication schedule configuration unit 164 and causing the communication schedule configuration unit 164 to perform the determination based on the information.

If the condition is satisfied in step S064 (Y in step S064), the communication schedule configuration unit 164 notifies the determined communication schedule to the communication schedule unit 162 (step S065). The communication schedule unit 162 determines a transmission timing of a packet based on the communication schedule notified from the communication schedule configuration unit 164.

When steps S061 to S063 are executed a plurality of times to plan a plurality of communication schedules, the best plan is notified to the communication schedule unit 162 based on a predetermined evaluation index. The evaluation index is, for example, a value obtained by weighting any one or more of the number of packets, the number of datagrams, and the communication bandwidth utilization rate. Priority and weight of the evaluation index may be set in the communication schedule configuration unit 164.

When the condition is not satisfied in step S064 (N in step S064), the processing returns to step S061. At this time, the step returned may be step S062 or S063 instead of S061, and may be different each time the processing returns from step S064. A destination to return to may be determined based on a determination result of step S064. For example, when the number of packets or the number of datagrams is equal to the ideal value, the processing returns to steps other than S061.

The communication schedule configuration unit 164 may determine a datagram of logical address assignment (setting of FMMU) to be transmitted to each control target device 121 based on the determined logical address configuration. In this case, at the time of initialization, the control device 120 may include a setting content of the FMMU in a datagram group and transmit the datagram group to the control target device 121.

### <Search Method and Optimization Method>

Any one or more of the configuration of the datagram by the datagram configuration determination unit 166 in step S061, the assignment of the logical address by the logical address determination unit 165 in step S062, and the transmission timing obtained by the communication schedule configuration unit 164 in step S063 may be determined using a search method or an optimization method. These methods include exhaustive search, a genetic algorithm, metaheuristics such as particle swarm optimization, and a combinatorial optimization algorithm.

When using these search methods and optimization methods, the ideal values of the number of datagrams and the number of packets described above may be set as the end conditions, or any one or more of the number of datagrams, the number of packets, and the communication bandwidth utilization rate set by a system operator or the like may be set as the end conditions. When a plurality of conditions are used, any one or more of the plurality of conditions, or all of the conditions may be set as the end condition.

### <Specific Example of Memory Integration>

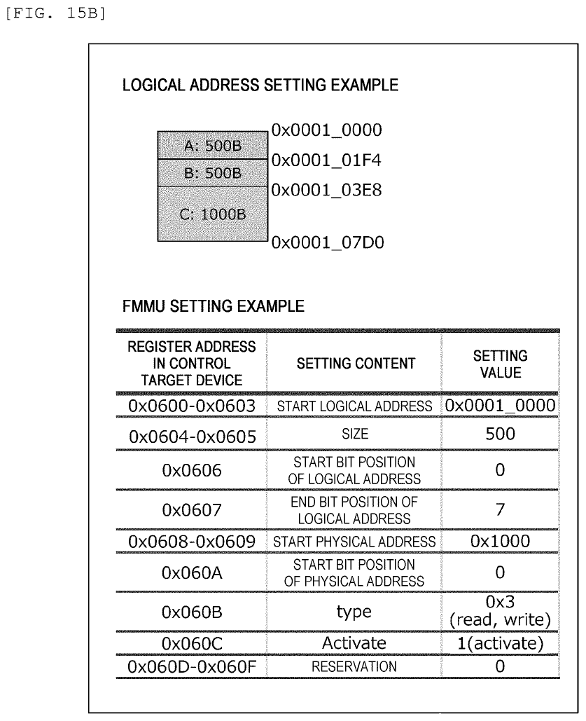

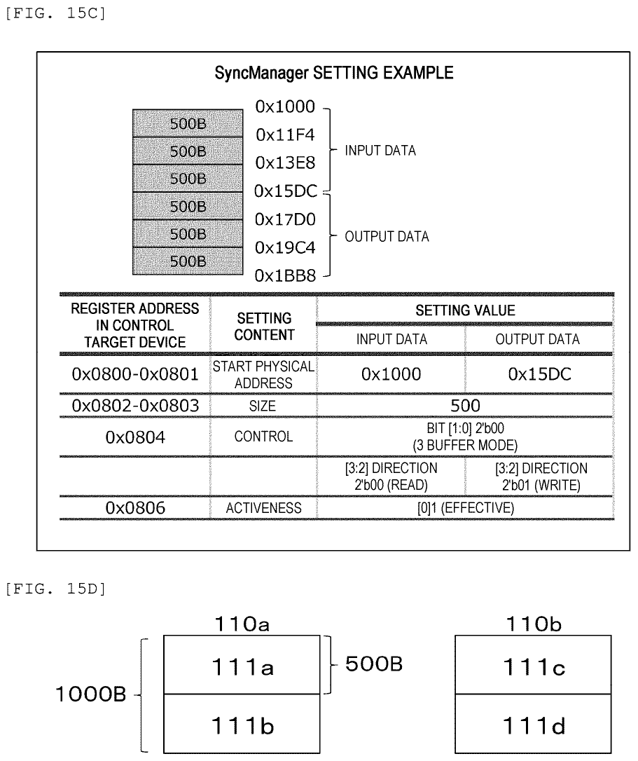

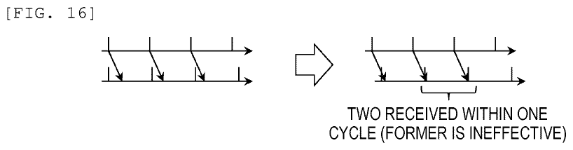

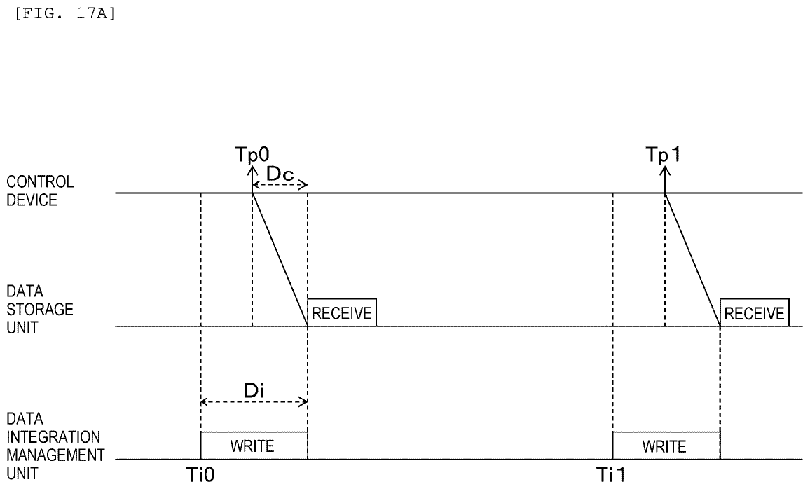

FIG. 15A is a diagram illustrating a specific operation example of the control target device 121 in FIG. 9. Here, it is assumed that the assignment of the logical addresses follows FIG. 14B. FIG. 15A shows a configuration example of the control system 123 including the control device 120 and the control target devices 121A, 121B, and 121C. In FIG. 15A, when focusing on the control target device 121A, the capacity of the data storage unit 153 is set to 4000 bytes, and a breakdown is as follows.
Input data: 500 bytes×3=1500 bytes
Output data: 500 bytes×3=1500 bytes
Mailbox communication: 1000 bytes

The input data is, for example, sensor information or status information acquired by the control target device 121A, and is data transmitted from the control target device 121A to the control device 120. The output data is, for example, control command information or setting update information for outputting the actuator in the control target device 121A, and is data transmitted from the control device 120 to the control target device 121A. The capacity for each of the input data and the output data is three times the originally required data capacity because of the exclusion control by SyncManager.

The input data and the output data serve as both input data and output data using the LRW command, and the communication data size is 500 bytes. FIG. 15B is a diagram showing the assignment of the logical addresses to each control target device 121 in FIG. 15A and an example of setting the FMMU for the control target device 121. The setting is executed in an initialization command for the control target device 121. Accordingly, a 500-byte space from 0x0001_0000 through 0x0001_01F3 of the logical address is assigned to the input and output of the control target device 121A.

FIG. 15C is a diagram showing the assignment of each area in the data storage unit 153 and a setting example of SyncManager in the control target device 121A shown in FIG. 15A. Here, a setting for the mailbox communication is not shown. Since it is necessary to set each of the input data and the output data, two SyncManagers are used, one for the input data and one for the output data. An unwritten register or bit is appropriately set.

FIG. 15D is a diagram showing an example of data assignment to the integrated data storage unit 155 performed by the data integration management unit 154 in the control target device 121A shown in FIG. 15A. As shown in FIG. 14A, the control target device 121A has an input and output size of 1000 bytes. Therefore, when processing the output data, in other words, the control data, the data integration management unit 154 needs to integrate and manage two sets of communication data obtained by dividing the size of the output data (1000 bytes) notified to the control target device 121A from the control device 120 by the size of the output data from the data storage unit 153, which is 500 bytes.

Similarly, when processing the input data, in other words, the control data, the data integration management unit 154 needs to integrate and manage two sets of communication data obtained by dividing the size of the input data (1000 bytes) notified to the control device 120 from the control target device 121A by the size of the input data from the data storage unit 153, which is 500 bytes. In this way, by dividing the input size of the control target device 121A by the input data size assigned in the data storage unit 153, the number of times of integrating and managing the input data can be calculated. Similarly, by dividing the output size of the control target device 121A by the output data size assigned in the data storage unit 153, the number of times of integrating and managing the output data can be calculated.

When the communication data size of each of the input data and the output data is equal to or greater than the input data size and the output data size assigned in the data storage unit 153, the number of times of integration and management and the number of times of communication are equal. On the other hand, when the data for the control target device 121 is distributed to a plurality of datagrams of a plurality of packets, or when the communication data size of each of the input data and the output data is less than the input data size and the output data size assigned in the data storage unit 153, the number of times of communication increases. Therefore, the number of times of integration and management and the number of times of communication are not equal.

The data integration management unit 154 needs to manage communication and data update of the data storage unit 153 until the necessary input size and output size are obtained. For example, when the communication data size of the datagram communicating the output data is 1000 bytes and the output data size assigned to the data storage unit 153 is 2000 bytes, the output data size of 2000 bytes is obtained by two times of communication (2000 bytes/1000 bytes=2).

Here, as shown in FIG. 15D, in the control target device 121A, two integrated memory areas of a memory 110a and a memory 110b constituting the integrated data storage unit 155 are prepared. Accordingly, for example, the calculation unit 160 can execute the calculation processing using the memory 110a in which all necessary partial areas 111a and 111b are already provided until all necessary partial areas 111c and 111d are provided in the memory 110b. In the specification, the memories 110a and 110b are collectively referred to as a memory 110, and the partial areas 111a to 111d are collectively referred to as a partial area 111. The number of the memories 110 may be three or more. Two memories 110 may be prepared for each of the input data and the output data.

For example, an operation will be described when the datagram as shown in FIG. 14B is communicated from the control device 120 to the control target device 121A. At a time point of a time offset 0 in a first 1 ms communication cycle (T[0]), the control target device 121A receives a datagram 180a of the LRW command having a total of 1000 bytes of data for the control target devices 121A and 121B (corresponding to Y in step S020 and step S021 in FIG. 9). The data integration management unit 154 stores the data corresponding to itself in the datagram 180a in the partial area 111a of the memory 110a (corresponding to steps S023 and S024 in FIG. 9).

Next, at a time point of a time offset of 500 μs in the same communication cycle T[0], the control target device 121A receives the datagram 180c of the LRW command having 500 bytes of data for the control target device 121A. The data integration management unit 154 stores the datagram 180c in the partial area 111b of the memory 110a.

At this time point, all the partial areas 111a and 111b of the memory 110a are obtained (corresponding to Y in step S025 in FIG. 9). In other words, the control data is prepared in the memory 110a corresponding to an integrated memory area obtained by integrating the partial areas 111a and 111b by writing the partial data in the partial areas 111a and 111b. The data integration management unit 154 notifies the calculation unit 160 and grants an access right of the memory 110a to the calculation unit 160 (corresponding to step S026 in FIG. 9). The calculation unit 160 accesses the memory 110a, acquires necessary information, and executes predetermined calculation processing.

Thereafter, at the time point of the time offset 0 in the next 1 ms communication cycle (T[1]), the control target device 121A receives the datagram 180a and stores necessary portion in the partial area 111c of the memory 110b. Next, at a time point of a time offset of 500 μs in the same communication cycle T[1], the control target device 121A receives the datagram 180c and stores the datagram 180c in the partial area 111d of the memory 110b.

At this time point, all of the partial areas 111c and 111d of the memory 110b are obtained, the data integration management unit 154 notifies the calculation unit 160 and grants the access right of the memory 110b to the calculation unit 160. The data integration management unit 154 deactivates the memory 110a or disables the access from the calculation unit 160, and waits for reception of the output data in the next cycle communication. Thereafter, such a series of operations is repeatedly executed.

From the viewpoint of software, the memory 110 can be represented by the following pseudo code:

unsigned char memory [2]; // memory 110a, 110b

The data integration management unit 154 grants an appropriate access right of the memory 110 to the calculation unit 160 by processing such as a pointer in the C language or encapsulation in an object-based language. When switching between the memories 110a and 110b, for example, appropriate exclusion control (such as a semaphore or a mutex) is executed. Although this is the case in which the access to the memories 110a and 110b is managed by software, the memories 110a and 110b may be managed by hardware such as an IC or FPGA, and may be hidden from the software.

The partial area 111 of the memory 110 to which the received output data corresponds may be determined based on the order in which the data is received, or may be determined based on the reception time instant. By sharing the communication cycle between the control device 120 and the control target device 121 in advance, the control target device 121 can determine what number the communication cycle is based on the reception time instant. At this time, a start time instant may be shared between the control device 120 and the control target device 121, or a time instant at which the control target device 121 first receives after the start of the processing may be set as the start time instant and stored in the control target device 121.

Examples of the information sharing between the control device 120 and the control target device 121 include the use of mailbox communication. Alternatively, information designating what number the communication is, or designating either the memory 110 or the partial area 111, or both, may be stored in the communication data. In this case, information such as a header may be used, or a packet or a data area on a datagram may be used.

Alternatively, address information indicating the position of the partial area 111 in the memory 110 may be stored in the data area on the packet or the datagram. In this case, when a physical address of a built-in RAM of an EtherCAT slave is 16 bits (64 kB) and an effect of using a space larger than the built-in RAM as the integrated data area is expected, a bit width of the address needs to be larger than 16 bits.

At a time point where the data of the partial area 111 is received, the data integration management unit 154 may activate only the partial area 111 so that the calculation unit 160 can access it. For example, when the data of the partial area 111a is received and the data of the partial area 111b is not received, the calculation unit 160 may be implemented to be able to use the data of the partial area 111a.

In this case, when the calculation unit 160 accesses the partial area 111b, the data integration management unit 154 or the integrated data storage unit 155 is implemented to return an error to the calculation unit 160. The data integration management unit 154 or the integrated data storage unit 155 may notify the calculation unit 160 that the partial area 111a is effective and the partial area 111b is ineffective. In such a configuration, the number of the memory 110 may be only one.

The same applies to communication of the input data such as sensor data acquired by the control target device 121, and the operation is as follows. The memory 110a and the memory 110b used in the following description are for the input data, and are provided separately from the memory 110a and the memory 110b for the output data described above.

First, when the calculation unit 160 obtains necessary input data for the first communication cycle of 1 ms, the calculation unit 160 transfers the data to the data integration management unit 154 (corresponding to step S035 in FIG. 10). The data integration management unit 154 writes the transferred input data in the memory 110a (corresponding to Y in step S040 in FIG. 11). The data integration management unit 154 transfers the input data written in the partial area 111a of the memory 110a to the access exclusion control unit 152 so that the input data can be stored in the datagram 180a of the LRW command received at the time offset 0 shown in FIG. 14B (corresponding to step S043 shown in FIG. 11). The access exclusion control unit 152 writes the transferred input data in the data storage unit 153.

Similarly, the data integration management unit 154 transfers the input data written in the partial area 111b of the memory 110a to the access exclusion control unit 152 so that the input data can be stored in the datagram 180c of the LRW command received at the time offset of 500 μs shown in FIG. 14B. The access exclusion control unit 152 writes the transferred input data in the data storage unit 153.

Concurrently, when the calculation unit 160 obtains the necessary input data for the next 1 ms communication cycle, the input data is transferred to the data integration management unit 154. The data integration management unit 154 writes the new input data transferred from the calculation unit 160 in the memory 110b in order to maintain the consistency of the memory 110a. In the subsequent cyclical operations, the data integration management unit 154 writes the input data transferred from the calculation unit 160 alternately in the memory 110a and the memory 110b.

For the next 1 ms communication cycle, the data integration management unit 154 transfers the input data written in the partial area 111c of the memory 110b to the access exclusion control unit 152 so that the input data can be stored in the datagram 180a of the LRW command received at the time offset 0. The access exclusion control unit 152 writes the transferred input data in the data storage unit 153.

Subsequently, the data integration management unit 154 transfers the input data written in the partial area 111d of the memory 110b to the access exclusion control unit 152 so that the input data can be stored in the datagram 180c of the LRW command received at the time offset of 500 μs. The access exclusion control unit 152 writes the transferred input data in the data storage unit 153. Thereafter, such a series of operations is repeatedly executed.

With the above configuration, even if the storage capacity of the data storage unit 153 is limited in the transfer of the output data from the control device 120 to the control target device 121 and the transfer of the input data from the control target device 121 to the control device 120, it is possible to perform data communication with a larger size in the communication with the calculation unit 160. That is, in the example, the storage capacity of the data storage unit 153 is limited to 500 bytes for each of the input data and the output data, and the calculation unit 160 can virtually communicate data of 1000 bytes using the memories 110a and 110b constituting the integrated data storage unit 155.

### <Specific Operation of Control Device 120>

The integration and division of the output data and the input data in the control target device 121 described above are the same in the control device 120. In transmission processing from the control device 120 to the control target device 121, the integrated data calculated and updated by the calculation unit 160 is written in the transmission data storage unit 161. The communication schedule unit 162 divides and transmits the integrated data written in the transmission data storage unit 161 according to the communication schedule determined by the communication schedule configuration unit 164.

On the other hand, in reception processing from the control target device 121 to the control device 120, the received data integration management unit 169 writes the sequentially received information in the received data storage unit 170, integrates the information, and notifies the calculation unit 160 of the update of the received data. At this time, either one or both of the transmission data storage unit 161 and the received data storage unit 170 may have the functions of exclusion control of writing and reading and simultaneous execution, similar to the access exclusion control unit 152 in the control target device 121.

### <Write Timing of Input Data to Data Storage Unit 153>

In the cyclical communication from the control device 120, the write of the input data from the data integration management unit 154 to the data storage unit 153 via the access exclusion control unit 152 is non-synchronously executed at a timing when Y in step S042 in FIG. 11. In this case, the communication cycle of the control device 120 is shared with the control target device 121, and the control target device 121 manages the timing of step S042 in FIG. 11 for each communication cycle.

However, in such a configuration, due to an error in a time instant management function (a crystal oscillator or a software timer) between the control device 120 and the control target device 121, there arises a problem that data is not updated or data is redundantly updated within the same cycle. In the time instant management functions of the control device 120 and the control target device 121, for example, since a time error is generated due to an individual difference of the crystal oscillator, the error is accumulated even when the same cycle is measured.

FIG. 16 is a schematic view showing an example of a problem when an error occurs in time instant management between the control device 120 and the control target device 121. As shown in FIG. 16, if an accumulated error of the time instant management is large, a cycle deviation occurs, and a case in which the input data in the data storage unit 153 is redundantly updated within the same communication cycle or a case in which the input data is not updated within a certain communication cycle occurs. When the input data in the data storage unit 153 is redundantly updated within the communication cycle, the previously updated input data is overwritten and becomes ineffective.

In such a situation, since appropriate sensor data or the like is not transmitted to the control device 120, control processing or the like is not appropriately calculated, and as a result, control performance of the control system 123 decreases. In order to prevent such a cycle deviation, a configuration is exemplified in which cyclical communication from the control device 120 and write of input data to the data storage unit 153 by the data integration management unit 154 are synchronized.

### <When Time Synchronization by DC is Performed>

For example, the control device 120 and the control target device 121 can be synchronized by a time synchronization protocol such as DC executed by the time synchronization unit 156 in the control target device 121 shown in FIG. 6. Then, the data integration management unit 154 controls the write of the input data to the data storage unit 153 (timing when Y in step S042 in FIG. 11 is determined) based on the synchronized time instant.

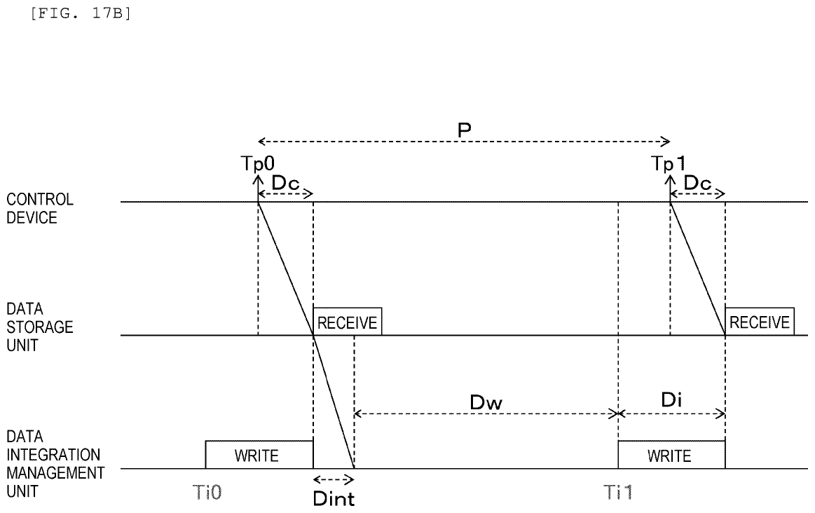

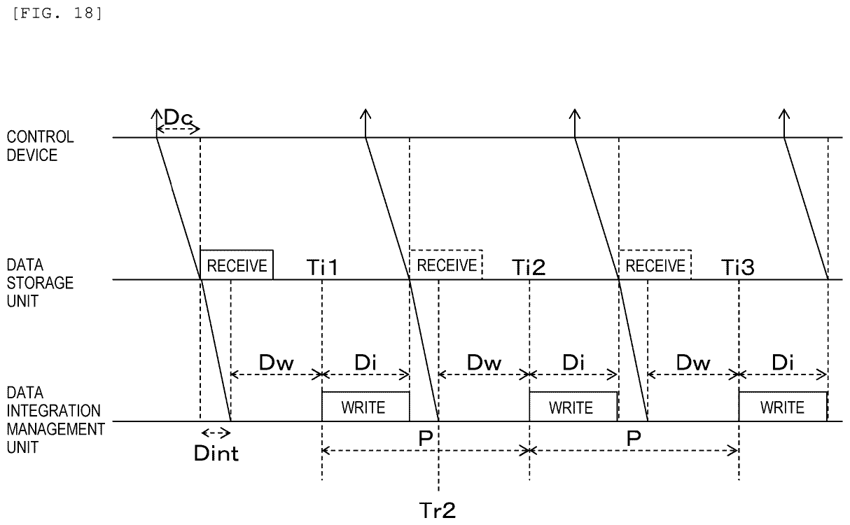

FIG. 17A is a time chart showing an operation example when the data integration management unit 154 in FIG. 6 writes input data in the data storage unit 153 on the premise that the time synchronization is performed. In FIG. 17A, a description is given focusing on one control target device 121.

In FIG. 17A, Tp0 and Tp1 are cyclical transmission timings from the control device 120. Dc is a communication delay from the control device 120 to the control target device 121. In the case of a real-time network such as EtherCAT, Dc can be determined with high accuracy and in a definite manner. Di is a write time of input data to the data storage unit 153 by the data integration management unit 154. Di may include a margin considering a maximum value of the jitter in the processing time by the data integration management unit 154 or the access exclusion control unit 152.

A time instant TiN (N is a cycle identifier) at which the data integration management unit 154 starts writing the input data, that is, the timing when Y in step S042 in FIG. 11 is determined, can be determined by Formula (1).

$$TiN = TpN + Dc - Di \qquad ( 1 )$$

In order to calculate Formula (1), TpN or a method for determining TpN may be shared in advance between the control device 120 and the control target device 121. Specifically, for example, when the communication cycle of the control device 120 is 1 ms, a rule may be established such that the control device 120 starts communication when a last time instant of the synchronized time instant (unit: ns) by DC is a multiple of 1000000 ns.

Alternatively, in order to calculate Formula (1), a next scheduled transmission time instant may be included in the communication from the control device 120. In this case, the communication is not limited to cyclical communication, and the transmission timing of the control device 120 and a write timing of the input data performed by the data integration management unit 154 can be determined at any communication timing. If the control device 120 and the control target device 121 are synchronized in time, the data integration management unit 154 can determine the time instant to start the write of the input data in the way.

When the data integration management unit 154 cannot be activated before the write timing of the input data (when the input data cannot be activated in time) due to an implementation constraint such as software, it is exemplified that the input data is not written. A predetermined notification method may notify the outside that the input data is not written in time. According to the notification, the system operator or the like takes measures such as reviewing the implementation of the control target device 121, and reliability of the operation of the control system 123 can be improved. Examples of a notification method to the outside include an interrupt via EtherCAT (use of an IRQ on a datagram header), or a visual method using an LED, a human machine interface, or the like on the control target device 121 or the control device 120.

### <When Time Synchronization is not Performed>

FIG. 17B is a time chart showing an operation example when the data integration management unit 154 in FIG. 6 writes the input data in the data storage unit 153 on the premise that the time synchronization is not performed. When the time synchronization by DC or the like is not executed due to the constraint of the corresponding functions of the control device 120 and the control target device 121 or the reason of the operation of the control system 123, the write timing of the input data by the data integration management unit 154 may be determined as shown in FIG. 17B.

In FIG. 17B, the data integration management unit 154 uses a timer function (not shown in FIG. 6 and the like) to activate a timer each time a packet associated with cyclical communication is received from the control device 120, thereby determining the write timing of the input data. In FIG. 17B, P is a communication cycle of the control device 120. Dint is a delay time from when the control target device 121 starts receiving a packet from the control device 120 to when the control target device 121 notifies the data integration management unit 154. An interrupt is generally used for the notification. When the interrupt is used, the configuration is such that the interrupt is generated by the reception of the packet or the write to the built-in RAM via SyncManager. Dw is a set time of the timer.

At the time instant TiN, the data integration management unit 154 starts the write of the input data in the data storage unit 153 by an interrupt activation or the like due to a time-out after the set time of the timer elapses. At this time, a time-out time of the timer can be determined by Formula (2).

$$Dw = P - Dc - Dint ( Di - Dc ) = P - Dint - Di \qquad ( 2 )$$

In general, since Dint is often smaller than other parameters, Dint may be ignored or may be included in a margin of other parameters.

As described above, when the write of the input data by the data integration management unit 154 is controlled in synchronization with the cyclical communication from the control device 120, the problem of the cycle deviation can be avoided. The configuration is based on the premise that an error between the time instant management functions of the control device 120 and the control target device 121 is sufficiently small, a cycle deviation does not occur until a time-out by a timer occurs, and there is no problem of the input data not being updated in time for cyclical reception of the packets from the control device 120 due to a time instant error.

The data integration management unit 154 may write the input data in response to reception of a cyclical packet from the control device 120 without setting the timer. Alternatively, the data integration management unit 154 may cause the timer to operate cyclically during a period in which there is no influence of the accumulated error of the time instant management function after activating the timer by the interrupt due to the reception of the packet, instead of activating the timer by the interrupt each time the packet is received.

### <Synchronization Method When Packet Loss Occurs>

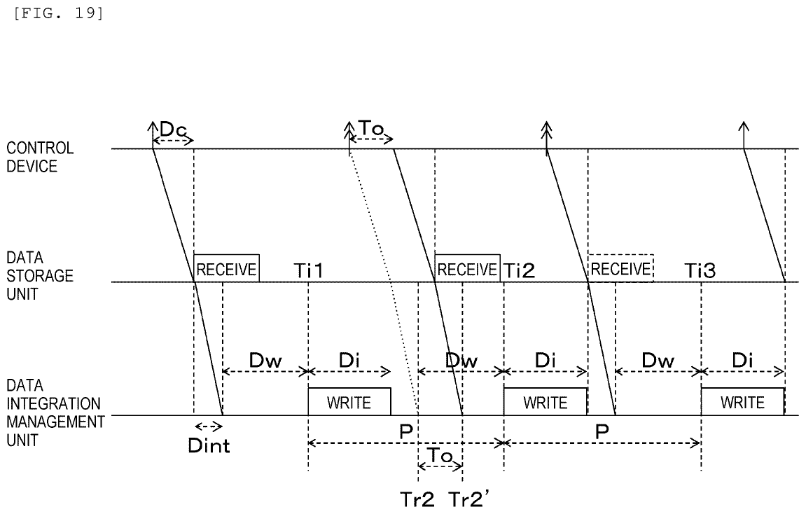

FIG. 18 is a time chart showing an operation example that is a modification of FIG. 17B. As shown in FIG. 17B, when the timer is started based on the communication from the control device 120, packet loss may occur in the communication from the control device 120. In such a case, as shown in FIG. 18, the set time of the timer may be updated again.

In FIG. 18, it is exemplified that, when the data integration management unit 154 is activated by a timer interrupt (for example, time-out) at Ti1, the data integration management unit 154 sets the cycle P at the time point of Ti1 and starts the timer so that a time-out interrupt occurs at Ti2. In addition, in consideration that the packet loss continues, it is exemplified that the data integration management unit 154 sets the cycle P at the time point of Ti2 and starts the timer so that the timer interrupt occurs at Ti3. In this way, the update is performed again every time the timer interrupt is performed.

Alternatively, the data integration management unit 154 may observe an elapsed time and update the input data each time the cycle is accumulated. However, in this case, since the time instant error is accumulated due to the error of the time instant management function, the data integration management unit 154 may correct a time-out period to be updated from the cycle P based on accuracy of the time management function.

For example, when the accuracy error of oscillators of the control device 120 and the control target device 121 is 50 ppm and the cycle P is 1 ms, an error of 100 ns (100 ns=1 ms×(50 ppm×2)) at maximum occurs in the control device 120 and the control target device 121 every time the cycle elapses. Therefore, when updating the set time of the timer, a value obtained by subtracting the error of 100 ns from the cycle of 1 ms may be set as a time-out value. By generating the timer interrupt earlier in consideration of the time instant error, the data integration management unit 154 can update the input data before communication from the control device 120.

When the packet loss continues and it is predicted that the accumulated error of the time instant management function cannot be ignored, the setting of the timer may be stopped and a failed state may be notified to the outside. Examples of a notification method to the outside include an interrupt via EtherCAT (use of an IRQ on a datagram header), or a visual unit using an LED, a human machine interface, or the like on the control target device 121 or the control device 120.

In addition, for example, the data integration management unit 154 may set the cycle P as a time-out value in the timer at the timing of Ti1 shown in FIG. 18, and thereafter, may interrupt the timer at the timing (for example, Tr2 shown in FIG. 18) at which the packet from the control device 120 is received, and may change the set time (time-out time) of the timer to Dw.

### <Synchronization Method for Retransmission and Redundancy>

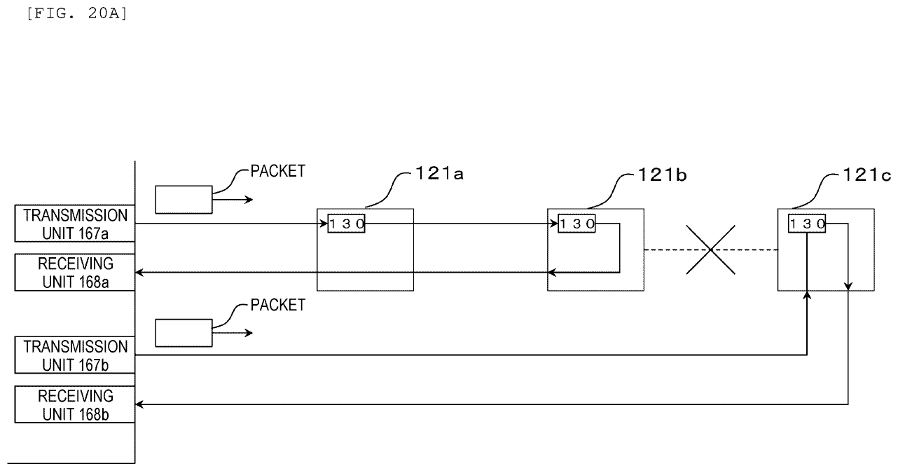

FIG. 19 is a time chart showing an operation example when the data integration management unit 154 in FIG. 6 writes the input data in the data storage unit 153 on the premise that retransmission and cable redundant communication are performed. The control device 120 may perform the retransmission or the cable redundant communication in order to improve reliability of communication. In this case, a reception timing of the packet in the control target device 121 may be delayed. In the example shown in FIG. 19, a reception timing Tr2 is delayed to Tr2′. Correspondence in this case will be described.

In general, when normal communication cannot be confirmed before a predetermined period (time-out time) elapses (for example, when a normal packet cannot be received), the control device 120 determines that a failure occurs and retransmits a transmission packet. In this case, the reception timing is delayed by the time-out time. In addition, since the retransmission may be performed a plurality of times, a delay corresponding to a time-out time corresponding to the number of times of retransmission may occur. In addition, when the cable redundant communication is performed, since a communication path of the packet may change, the reception timing in the control target device 121 also changes in this case. In this case, the reception timing may not only be delayed but also be advanced.

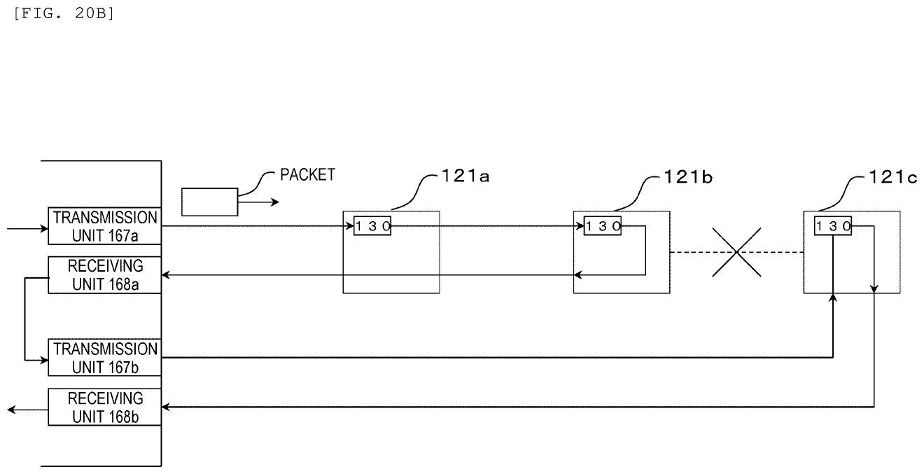

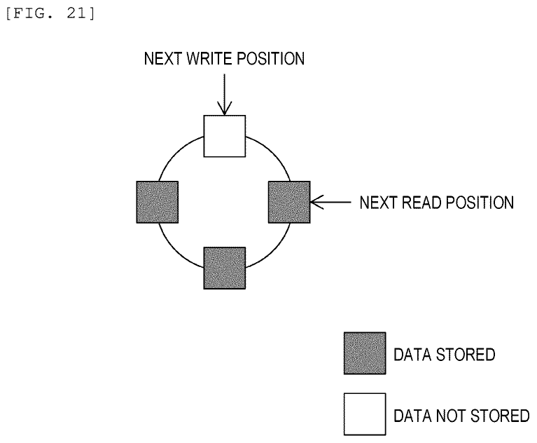

FIGS. 20A and 20B are schematic views showing an example of a situation in which a cable failure occurs between the control target device 121b and the control target device 121c. In FIG. 20A, the control device 120 transmits packets from both of the two communication ports including transmission units 167a and 167b. Focusing on the reception timing of the control target device 121c, when the path is normal, the control target device 121c receives the packets after passing through the control target devices 121a and 121b. On the other hand, when a cable failure occurs, the control target device 121c first receives the packet transmitted from the transmission unit 167b as a single packet. In this case, the reception timing of the packet may be earlier than normal.

In FIG. 20B, when the cable failure occurs, the control device 120 transmits the packet from the transmission unit 167a, and after the packet is received by the receiving unit 168a, the packet is transferred to the transmission unit 167b. Focusing on the reception timing of the control target device 121c, since the communication path becomes long, the reception timing of the packet in the control target device 121c is delayed.

The control target device 121 first determines whether the received packet is a packet due to the retransmission or the cable redundant communication. At this time, the control target device 121 may perform the determination by comparing the reception timing of the packet when there is no failure with a reception timing of a determination target packet and comparing a time difference with a predetermined threshold value. The reception timing of the packet when there is no failure may be a time instant obtained by adding the cycle P to the reception timing in the previous normal state. The time instant of the reception timing may be a time instant synchronized by a synchronization protocol such as DC, or may be a time instant of the control target device 121 itself. Since it is not necessary to compare the time instant with the control device 120 or another control target device 121, the time instant of the control target device 121 itself can be used.

Alternatively, the control device 120 may indicate that the retransmission is performed in a parameter (for example, an index of an EtherCAT datagram header) on the packet when the retransmission is performed. Further, it may also indicate which retransmission occurs within the same cycle. Alternatively, as shown in FIG. 20B, when transferring the packet from the transmission unit 167b, the control may device 120 reflect the redundant communication in a parameter on the packet. It is exemplified that the control target device 121 determines the retransmission or the cable redundancy when the control target device 121 detects these parameter values for the received packet.

When the control target device 121 receives a packet associated with the retransmission or the cable redundant communication, the control target device 121 may control an update timing of the input data using a time-out value obtained by adding the cycle P as shown in FIG. 18 without updating the timer interrupt due to the received packet. Alternatively, when the delay time of the reception timing is clear, the control target device 121 may change the time-out time of the timer using the value. For example, in the case of the retransmission, since the control device 120 performs the retransmission after time-out, the delay time is known.

More specifically, it is exemplified that a time-out time To is shared between the control device 120 and the control target device 121, and the control target device 121 sets the timer by correcting the time-out time using Formula (3) when the retransmission packet is received.

$${Dw}^{′} = Dw - To \times Cr \qquad ( 3 )$$

Here, Cr is the number of retransmissions, and the control target device 121 can be identified by the control device 120 reflecting the number of retransmissions in the parameter on the packet.

Even in the case of the cable redundancy, if an amount of change in the communication delay due to a change in the communication path of the packet is known, the time-out time can be calculated in the same manner by replacing To×Cr in Formula (3). To make this possible, in the configuration shown in FIG. 20B, it is exemplified that the control device 120 reflects a cable failure location in the parameter on the packet when transferring the packet to the transmission unit 167b.

At this time, the control device 120 includes a datagram (for example, a BRD command) for updating the WKC in response to all the control target devices 121 in the packet, and when the packet is received by the receiving unit 168a at the time of the cable failure, the control device 120 can determine the cable failure location by checking a WKC value. If the location of the occurrence of the cable failure is known, the control target device 121 can calculate a delay change due to the cable redundant communication based on a packet transfer time of each control target device 121, a packet transfer time of the control device 120, a cable length between the control target devices 121, and the like.

According to the above method, it is possible to solve the problem that the data is not updated or the data is redundantly updated within the same cycle due to a cycle deviation. The above configuration is not limited to the configuration based on EtherCAT, and can be applied to, for example, a configuration based on an IEEE 802.3 communication standard having a communication bandwidth of 1 Gbps or more or a communication system having a large frame size such as a jumbo frame.

### <Assignment of Multiple Slaves to Same Logical Address>

The same logical address may be assigned to different control target devices 121. With such a configuration, when data is integrated and managed by the data integration management unit 154 and the integrated data storage unit 155 of each control target device 121, higher reliability can be achieved by redundancy of processing. For example, by connecting a physically common input and output device to a plurality of control target devices 121, input and output control can be highly reliable.

### <Dynamic Change of Number of Divisions and Communication Schedule>

The number of partial areas divided when the data integration management unit 154 and the integrated data storage unit 155, and the received data integration management unit 169 and the received data storage unit 170 perform integration may be changed depending on the state of the control system 123 or the control target device 121. In this case, a control recipe in the control system 123 is changed.

That is, the control cycle and the input and output size of the control target device 121 may be changed due to a change in state or a change in the control recipe. Alternatively, the control system 123 or the control target device 121 is a mobile object, and an execution operation may change depending on a position thereof. For example, a required control cycle or input and output size may change between a case in which a movable picking robot is simply moving and a case in which a picking operation is performed near a conveyor or another robot. In this case, the number of partial areas divided may also change.

When the control device 120 changes the number of partial areas divided, the control cycle, the input and output size, and the like in the control target device 121, the control device 120 may notify the control target device 121 of changed information. The notification may be made using mailbox communication or a dedicated format. Examples of the dedicated format include any one or more of a change in information, a type of information to be changed, and a changed value.

In such a case, for example, the configuration of the communication schedule made by the communication schedule configuration unit 164 shown in FIG. 13 or FIGS. 14A to 14D may be e re-executed. Specifically, the communication schedule configuration unit 164 may perform the re-execution during the state change or may perform the re-execution before the state change and store an execution result.

As described above, the communication schedule configuration unit 164 re-executes the configuration of the communication schedule by changing the state of the control system 123 or changing the control recipe. As a result, the assignment of the address space of each control target device 121 to the logical address space, the size of the datagram, the logical address or command of the access destination, the transmission timing, and the communication cycle, which are components of the communication schedule, may be dynamically changed.

### <Non-Constant Number of Divisions>

The number of partial areas divided when the data integration management unit 154 and the integrated data storage unit 155, and the received d integration management unit 169 and the received data storage unit 170 perform integration may not be the same number of cycles for each set. For example, in the first set, the partial areas are integrated with data for one cycle, in the next set, the partial areas are integrated with data for three cycles, and in the next set, the partial areas are integrated with data for five cycles, and thereafter, an operation of repeating the set of one cycle, set of three cycles, and set of five cycles may be performed.

Such an operation is effective when the control system 123 repeats and a pattern operation associated with the repetition is appropriate. In order to achieve this, for example, a pattern of the cycle may be stored in the control target device 121 in advance, or the control target device 121 may be notified from the control device 120.

### <Discontinuous Partial Area>

The partial areas to be integrated into the data integration management unit 154 and the integrated data storage unit 155, or in the received data integration management unit 169 and the received data storage unit 170, do not necessarily need to be continuous according to the order of reception, and may be irregular in order. This is because there may be a case in which the order that a transmission side can prepare is discontinuous, or a situation in which a reception side cannot receive data in order due to the packet loss, the retransmission, or the like.

Since a transmission order does not need to be continuous by corresponding to the discontinuous partial area, the transmission side can have a degree of freedom in data to be transmitted, and the degree of freedom of an application on the transmission side can be similarly improved. As a specific example of a method for dealing with this, for example, information indicating the order of data may be included in transmission data whose order is not continuous.

### <Functional Sharing Through Multi-CPU and Multi-Core Utilization>

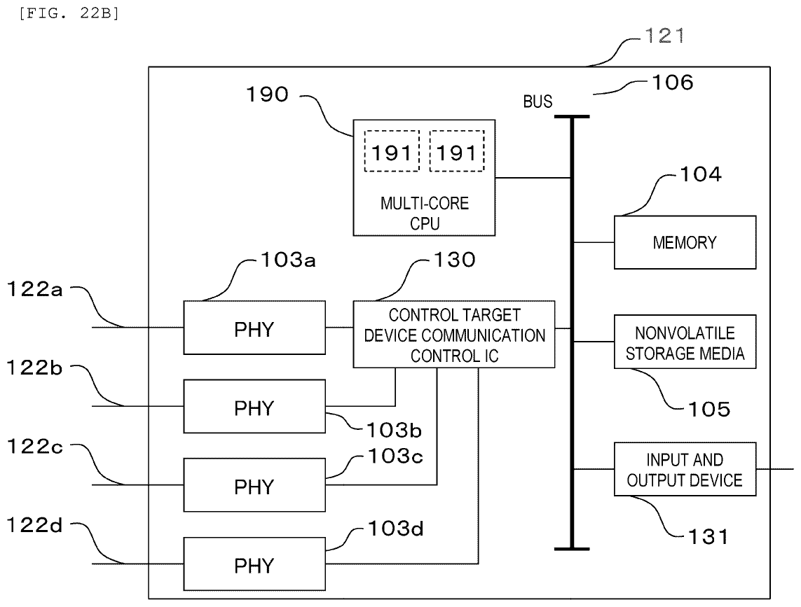

FIGS. 22A and 22B are block diagrams showing a configuration example obtained by modifying the hardware structure of the control target device 121 shown in FIG. 4. In FIG. 22A, instead of the CPU 101 shown in FIG. 4, a multi-CPU including a plurality of CPUs 101a and 101b is provided. In FIG. 22B, instead of the CPU 101 shown in FIG. 4, a multi-core CPU 190 having a plurality of CPU cores 191 is provided.

In such a configuration, the data integration management unit 154 and the integrated data storage unit 155 shown in FIG. 6 may be provided for each of the plurality of CPUs 101a and 101b or each of the plurality of CPU cores 191. When the integrated data storage unit 155 is implemented using the memory 104 or the nonvolatile storage media 105, a plurality of the memories 104 or the nonvolatile storage media 105 may be physically provided, and a recording area of the memory 104 or the nonvolatile storage media 105 may be divided for each of the plurality of CPUs 101a and 101b or each of the plurality of CPU cores 191.

In the data storage unit 153 in the control target device communication control IC 130, the same storage area may be shared by the plurality of CPUs 101a and 101b or the plurality of CPU cores 191, or the storage area may be shared by each of the plurality of CPUs 101a and 101b or each of the plurality of CPU cores 191. The communication schedule configuration unit 164 in the control device 120 may determine a communication schedule by regarding the plurality of CPUs 101a and 101b or the plurality of multi-core CPUs 190 in the control target device 121 as one communication destination, or may determine a communication schedule by regarding them as individual communication destinations.

According to such a configuration, each of the CPUs 101a and 101b and each of the CPU cores 191 can execute a dedicated function (for example, control, maintenance, diagnosis, or preventive maintenance). As a result, it is possible to improve the function and performance of the control target device 121 while executing a plurality of calculation functions, and it is possible to improve the performance and the level of the control system 123.

### <Multiple Control Devices 120>

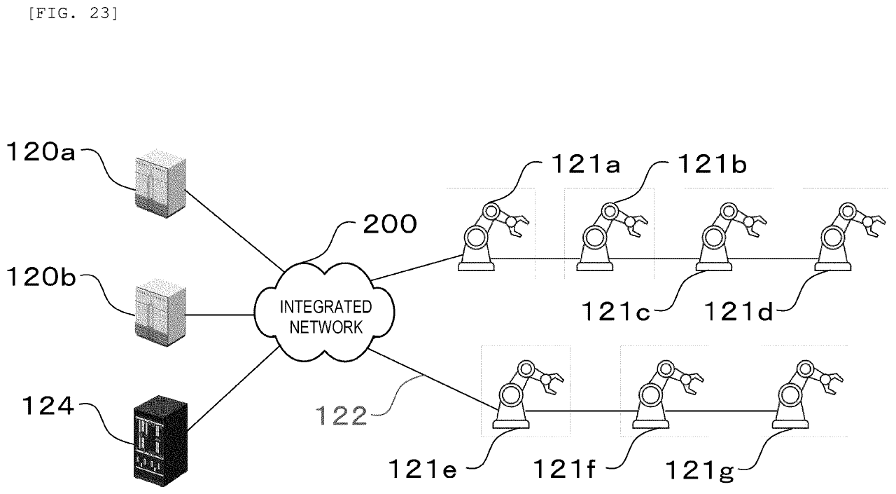

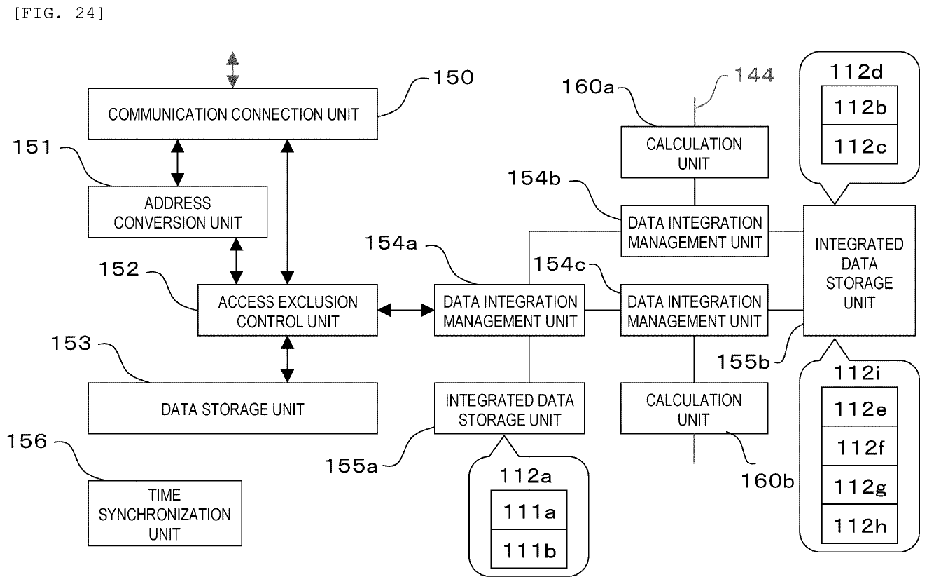

FIG. 23 is a schematic view showing a configuration example in which the control communication system shown in FIG. 1 is modified. In FIG. 23, unlike the case of FIG. 1, a plurality of control devices 120a and 120b control a group of the control target devices 121 via an integrated network 200. In the specification, the plurality of control devices 120a and 120b are collectively referred to as the control device 120. The control communication system shown in FIG. 23 includes a plurality of groups of control target devices 121, that is, a group of control target devices 121 including control target devices 121a to 121d, and a group of control target devices 121 including control target devices 121e to 121g, but may also include a single group of control target devices 121.

The integrated network 200 is a network that satisfies constraints on construction of the control network 122 and enables the plurality of control devices 120 to control one or the plurality of groups of control target devices 121. Examples of the integrated network 200 include TSN. In this case, different control target devices 121 may be controlled (input and output data may be transmitted and received) for each individual control device 120, or the same control target device 121 may be controlled by a plurality of control devices 120.

An example of a case in which the same control target device 121 is controlled by a plurality of control devices 120 is a case in which distributed control of the same control target device 121 is performed between the plurality of control devices 120. In this case, the data integration management unit 154 of the control target device 121 may control the assignment position of the received data to the integrated data storage unit 155 or the transmission data to the control device 120 based on the identification of the control device 120 when integrating and managing the input and output data to the integrated data storage unit 155. When identifying the control device 120, a transmission source address on a packet (such as a source MAC address of a header of an IEEE 802.3 frame) may be used, or an identifier of the control device 120 may be included on a packet (such as an index of an EtherCAT datagram header).

A certain control device 120 may adjust the transmission timing with another control device 120 and shift the transmission timing. In addition, another control device 120 may be implemented to receive a communication packet from the control device 120 or the control target device 121.

With the above configuration, it is possible to integrate and manage the received data in the received data integration management unit 169 of the control device 120. A load can be distributed by the distributed control by the plurality of control devices 120. Further, when the control device 120 fails, another control device 120 substitutes for the process, and thus the operating rate of the control system 123 can be improved, and high reliability can be achieved. Alternatively, by adjusting the number of control devices 120 in response to a performance request of the control system 123, the control system 123 can be optimally executed from the viewpoint of device cost, energy consumption, and the like. That is, the number of control devices 120 may be dynamically changed according to an operating situation of the control system 123.

### <SyncManager and Access to Object>

For example, it is assumed that mailbox communication such as CAN application protocol over EtherCAT (CoE) or processing data communication is performed in EtherCAT. In this case, a method is used in which the built-in RAM (data storage unit 153) of the control target device 121 is divided, and each divided area is managed and accessed via SyncManager (the access exclusion control unit 152) to access an object.

In the embodiment, by providing the data integration management unit 154 and the integrated data storage unit 155, it is possible to obtain an effect of virtually increasing an effective data capacity of the built-in RAM accessible by SyncManager. Examples of a method for associating an object with a virtually increased effective data capacity include a method for newly defining an intermediate object.

The intermediate object manages the correspondence between the partial area included in the received datagram and a position in the integrated data storage unit 155 where the object to be accessed is stored. Therefore, examples of a component of the intermediate object include one or more combinations of the index of an object to be accessed and the position in integrated data storage unit 155.

When the datagram is received and the area on the data storage unit 153 mapped by the intermediate object is updated, the intermediate object acquires the data of the updated area and identifies the received data to update the data of the corresponding object in the integrated data storage unit 155. Therefore, an actual operation of the intermediate object can be said to be an operation based on the function of the data integration management unit 154. Accordingly, the application operating in the calculation unit 160 can access a target object by acquiring data of a necessary object from the area of the integrated data storage unit 155.

On the other hand, when transmission is performed from the control target device 121 to the control device 120, the received data integration management unit 169 and the received data storage unit 170 operate similarly to the data integration management unit 154 and the integrated data storage unit 155, respectively. That is, the received data integration management unit 169 identifies the received data, determines the corresponding object, and stores the received data at a position on the received data storage unit 170 where the target object is stored. Examples of methods for identifying the received data include using any one or more of a method for recognizing which cycle the data is received in, a method based on the reception time instant, and a method for including identification information in the information on the received data.

Examples of the above operations include executing using either a service data object (SDO), a process data object (PDO), or both.

The relationship between the intermediate object and the single or a plurality of target objects managed by the intermediate object may be defined in ESI or ENI as a vendor unique tag. In this case, examples of the information defined in the unique tag include identification information of the received data and information (index or the like) of the object corresponding to the received data. According to the definition, the control device 120 transmits the relationship of the target object managed by y the intermediate object to the control target device 121 as an initialization command defined in the ENI.

Similarly, the index of the intermediate object corresponding to SyncManager is defined in the ESI and the ENI. Alternatively, the relationship between the target object managed by the intermediate object may be defined by a unique method other than the ESI and the ENI.

The data integration management unit 154 (the received data integration management unit 169 in the case of the input data) may manage the effective data capacity by another method for associating the object with the virtually increased effective data capacity without providing the intermediate object. That is, when the datagram is received and the area on the data storage unit 153 is updated, the data integration management unit 154 acquires the data of the updated area and identifies the received data to update the data of the corresponding object in the integrated data storage unit 155.

As is clear from the association with the object, the data integration management unit 154 may set a partial area (an area managed by one SyncManager) of the data storage unit 153 (built-in RAM) as a partial area and integrate the partial area as an integrated data area on the integrated data storage unit 155.

### <Hierarchization and Parallelization>

FIG. 24 is a block diagram showing a configuration example obtained by modifying the functional configuration of the communication processing unit 140 shown in FIG. 6. So far, the integration by the data integration management unit 154 and the integrated data storage unit 155 in the control target device 121, and the received data integration management unit 169 and the received data storage unit 170 in the control device 120 are described. The partial areas used at this time may be managed hierarchically and in parallel. That is, as shown in FIG. 24, a plurality of data integration management units 154a to 154c and a plurality of integrated data storage units 155a and 155b may be provided in a hierarchical and parallel manner, and the data integration management units 154a to 154c may integrate the partial areas.

In FIG. 24, the data integration management units 154b and 154c are parallel to each other, and have a hierarchical structure with respect to the data integration management unit 154a. The data integration management unit 154a integrates the partial areas 111a and 111b into an integrated data area 112a using the integrated data storage unit 155a. Specifically, the data integration management unit 154a integrates, for example, two pieces of received data into one integrated data area 112a. Further, when the integrated data area 112a is effective, the data integration management unit 154a transfers the data in the integrated data area 112a to the data integration management units 154b and 154c.

The data integration management units 154b and 154c integrate the integrated data area 112a as the partial area. For example, the data integration management unit 154b writes the data of the two integrated data areas 112a from the data integration management unit 154a into the integrated data areas 112b and 112c to integrate the data, and generates the data of the integrated data area 112d for the calculation unit 160a. Similarly, the data integration management unit 154c writes the data of the four integrated data areas 112a from the data integration management unit 154a into integrated data areas 112e to 112h to integrate the data, and generates the data of an integrated data area 112i for the calculation unit 160a.

Therefore, the integrated data area 112d is constituted with a total of four pieces of received data, and the integrated data area 112i is constituted with a total of eight pieces of received data. In FIG. 24, the data integration management units 154b and 154c share the integrated data storage unit 155b, and the integrated data storage unit 155 may be provided in each of the data integration management units 154b and 154c.

By using the configuration shown in FIG. 24, it is possible to provide suitable for integrated data applications using different amounts of data, and therefore suitable for the calculation unit 160. For example, the calculation unit 160a executes a control application, and concurrent with this, the calculation unit 160b can execute a diagnosis application or an AI application that analyzes and diagnoses the input and output data and the control target device 121.

In addition, when the control system 123 or the requirements are changed, the size of the integrated data can be easily changed by taking a hierarchical structure or a parallel structure. In addition, the size of the integrated data for each calculation unit 160 can be changed without affecting the other calculation units 160. The hierarchical structure and the parallel structure may be implemented by a single device (for example, a CPU) or a plurality of devices (for example, a CPU, an ASIC, and an FPGA).

### <Deviation of First Data>

An example of this is when the control system 123 is started or resumed after an interruption, if the received partial area is not the first data, the received data is discarded until the first data is received. Examples of a method for determining whether the data is the first data include a method for determining based on the reception time instant of the received data or information on the received data. Accordingly, even when the start timings of the control device 120 and the control target device 121 do not coincide with each other, the timings can be matched.

<Effect of Utilizing Space Larger than Logical Address Space>

By using the method according to the embodiment, since data received by a command accessing a logical address space is treated as a partial area and a plurality of partial areas can be integrated, a data area larger than the logical address space can be used.

### <Effects of Remodeling, Discontinuation of Production, Discontinuation of Sales, and Discontinuation of Provision>

In the method according to the embodiment, the data integration management unit 154 and the integrated data storage unit 155 independent of the access exclusion control unit 152 (SyncManager) and the data storage unit 153 (built-in RAM) integrate the partial areas as the integrated data areas. Therefore, an IC different from an EtherCAT slave IC can be used as the data integration management unit 154 and the integrated data storage unit 155. Accordingly, since a degree of freedom of selection of the IC is improved, for example, it is possible to use a high-performance CPU or a CPU or a GPU specialized for specific processing. In addition, when a CPU or the like being used is remodeled, the CPU can be replaced with a different CPU, and it is possible to flexibly cope with the remodeling.

### <Overall Effects>

By using the method for the embodiment, even if the available area of the data storage unit 153 via the access exclusion control unit 152 is limited, it is possible to perform high-speed and large-capacity communication between the control device 120 and the control target device 121 by the integrated management of the data area by the data integration management unit 154 and the integrated data storage unit 155. Since the high-speed and large-capacity communication can be performed without increasing the effective data capacity (built-in RAM capacity) of special hardware such as the access exclusion control unit 152 (SyncManager), component cost can be reduced.

Further, the communication schedule configuration unit 164 including the logical address determination unit 165 and the datagram configuration determination unit 166 determines a datagram configuration and assigns the datagram configuration to the logical address, thereby preventing an increase in the number of packets and datagrams and reducing a communication overhead associated with the header and the IFG. Accordingly, the communication bandwidth can be effectively utilized. Other communication such as a setting and a state acquisition can be executed by utilizing the surplus communication bandwidth, and can be utilized for maintenance and diagnosis by visualization of the control target device 121 and the control system 123 and utilization of IoT. As a result, the operation of the control system 123 can be leveled up, and performance and an operating rate of the control system 123 can be improved.

Although the invention made by the present inventor has been specifically described based on embodiments, the invention is not limited to the embodiments, and various modifications can be made without departing from the gist of the invention. For example, the above-described embodiments have been described in detail to facilitate understanding of the invention, and the invention is not necessarily limited to those including all the configurations described above. In addition, a part of a configuration according to a certain embodiment can be replaced with a configuration according to another embodiment, and a configuration according to another embodiment can be added to a configuration according to a certain embodiment. In addition, another configuration can be added to, deleted from, or replaced with a part of a configuration of each embodiment.

For example, the above-described various programs may be stored in a non-transitory computer readable recording medium and then supplied to a computer. Examples of such a recording medium include a magnetic recording medium represented by a hard disc drive, an optical recording medium represented by a digital versatile disc (DVD) or a Blu-ray disc, and a semiconductor memory represented by a flash memory and a solid state drive (SSD).

### REFERENCE SIGNS LIST

110: memory (integrated data area)
111: partial area
120: control device
121: control target device
123: control system
152: access exclusion control unit
153: data storage unit
154: data integration management unit
155: integrated data storage unit
160: calculation unit
164: communication schedule configuration unit
165: logical address determination unit
166: datagram configuration determination unit
169: received data integration management unit
170: received data storage unit

1. A communication control device comprising:
a calculation unit configured to process control data;
a communication unit configured to transmit a packet including the control data; and
a data storage unit having an exclusion control function, wherein
the calculation unit
associates a position occupied by each of two or more pieces of partial data constituting the control data in the control data with an attribute related to the packet communicated by the communication unit, and
transmits and receives the partial data to and from the communication unit via the data storage unit.

2. The communication control device according to claim 1, wherein
the attribute related to the packet is any one or both of a communication timing of the packet and information indicating the position of the partial data stored in the packet.

3. The communication control device according to claim 1, wherein
the calculation unit
determines, for a received first packet, based on any one or more pieces of information on the packet, a communication timing of the packet, and effectiveness determination of a second packet received subsequent to the first packet, whether the first packet is effective, and
does not include the partial data included in the first packet in the control data when it is determined that the first packet is ineffective.

4. The communication control device according to claim 1, wherein
the calculation unit activates and processes the partial data as the control data based on any one or more of the number of pieces of the partial data, and a total size and a content of the partial data.

5. The communication control device according to claim 4, wherein
the calculation unit has an area storing first control data and an area storing second control data, and processes the already activated second control data until the first control data is activated.

6. The communication control device according to claim 1, wherein
the calculation unit writes the partial data in the data storage unit in synchronization with communication of the packet in the communication unit.

7. A control communication system comprising:
a first communication control device; and
a second communication control device controlled by the first communication control device, wherein
each of the first communication control device and the second communication control device includes
a calculation unit that processes control data,
a communication unit that transmits a packet including the control data, and
a data storage unit that has an exclusion control function,
the communication unit
associates a position occupied by each of two or more pieces of partial data constituting the control data in the control data with an attribute related to the packet communicated by the communication unit, and
transmits and receives the partial data to and from the communication unit via the data storage unit, and
the first communication control device determines, based on a control cycle in the second communication control device, a necessary data capacity per control cycle, and a capacity of the data storage unit, a communication schedule including a datagram configuration constituting the packet, a communication timing of the packet, an access destination address of the data storage unit of the second communication control device designated in the packet, and an assignment of the data storage unit of the second communication control device to a virtual area.

8. The control communication system according to claim 7, wherein
a plurality of the second communication control devices are provided,
the first communication control device
calculates the number of datagrams per control cycle based on the necessary data capacity per control cycle of the second communication control device and the capacity of the data storage unit,
calculates a communication cycle per datagram based on the control cycle,
sets a maximum value among the communication cycles of the plurality of second communication control devices as a basic communication cycle, and determines appending of datagrams such that an amount of packets in the basic communication cycle is equal to or less than an allowable amount, and
determines the assignment of the data storage unit of the second communication control unit to the virtual area based on a configuration of the appended datagrams.

9. The control communication system according to claim 7, wherein
the first communication control device determines the communication schedule using a search method.

10. The control communication system according to claim 8, wherein
the first communication control device determines, using
a maximum value of the number of transmission datagrams per basic communication cycle necessary for each of the plurality of second communication control devices, and
the number of packets obtained from a sum of the necessary data capacities per basic communication cycle in the plurality of second communication control devices and a maximum allowable size per packet,
a plan of the communication schedule when the number of packets per basic communication cycle coincides with a larger one of the maximum value of the number of transmission datagrams and the number of packets obtained from the maximum allowable size per packet.

11. The control communication system according to claim 7, wherein
the first communication control device assigns the data storage unit of the second communication control device to a plurality of areas on the virtual area.

12. The control communication system according to claim 7, wherein
the first communication control device is time-synchronized with the second communication control device,
the first communication control device transmits the packet based on a synchronized time instant, and
the second communication control device writes the partial data in the data storage unit based on the synchronized time instant.

13. The control communication system according to claim 7, wherein
the calculation unit in the second communication control device writes the partial data in the data storage unit after an elapse of a waiting time determined based on a transmission timing of the first communication control device from a time point at which the communication unit receives the packet.

14. The control communication system according to claim 13, wherein
the calculation unit in the second communication control device changes the waiting time based on any one of packet loss, retransmission, and transfer to a redundant path of the packet.

15. The control communication system according to claim 7, wherein
the control data is assigned to a predetermined data structure, and
an assignment of the data structure is shared between the first communication control device and the second communication control device.

16. The control communication system according to claim 7, wherein
the calculation unit in the second communication control device associates the position occupied by the partial data in the control data based on an identifier of the first communication control device.
